(19) United States
(12) Patent Application Publication
(10) Pub. No.: US 2023/0086767 A1
(43) Pub. Date: Mar. 23, 2023

(54) PEA PROTEIN COMPOSITIONS FOR REDUCING FAT ABSORPTION IN FRIED FOOD AND RELATED METHODS

(71) Applicant: KEMIN INDUSTRIES, INC., Des Moines, IA (US)

(72) Inventors: Stephen D. Kelleher, Ipswich, MA (US); Kristen Robbins Junker, Ankeny, IA (US); Wayne S. Saunders, Port Charlotte, FL (US)

(73) Assignee: KEMIN INDUSTRIES, INC., DES MOINES, IA (US)

(21) Appl. No.: 17/947,773

(22) Filed: Sep. 19, 2022

Related U.S. Application Data
(60) Provisional application No. 63/245,491, filed on Sep. 17, 2021.

(51) Int. Cl. A23P 20/10; A23J 3/14; A23L 5/10; A23P 20/17; A23P 20/18; A21D 13/22; A21D 2/26; A23L 19/00; A23L 31/00

(52) U.S. Cl. CPC A23P 20/11; A23J 3/14; A23L 5/11; A23P 20/17; A23P 20/18; A21D 13/22; A21D 2/266; A23L 19/05; A23L 31/00; A23V 2002/00

(57) ABSTRACT

The present invention relates to a “fat blocking” composition that contains pea protein, and optionally an antioxidant, for application to food, where the composition is capable of reducing the overall fat absorption by at least 20% when the composition is applied to the food prior to frying or cooking the food. Another aspect of the present invention relates to a process for preparing the pea protein composition to have a pH between about 4 to 6. Another aspect of the present invention relates to methods for reducing the overall fat absorption by coating an uncooked food with a composition that contains pea protein, and optionally an antioxidant, prior to frying, where the amount of oil and/or fat absorbed by the food during cooking is substantially reduced.

### CROSS-REFERENCE TO RELATED APPLICATIONS

This application claims the benefit of priority to U.S. Provisional Patent Application No. 63/245,491, filed Sep. 17, 2021, the entire disclosure of which is incorporated herein by reference.

### BACKGROUND OF THE INVENTION

The invention relates to a process for controlling oil and fat absorption in food cooked in oil or fat by applying “fat blocking” compositions to the surface of uncooked food, where the fat blocking compositions contain a pea protein solution or blend, and optionally antioxidants and/or polysaccharides derived from mushrooms, which maintain the stability and quality of the fat block and the fried food.

The consumption of fried food is ubiquitous throughout the world with an estimated $83 billion consumed every year in the United States, and at least twice that amount for the rest of the world. E. Choe and D. B. Min Chemistry of Deep-Fat Frying Oils, J. of Food Sci., Vol 72 (5) 2007. Health concerns from frying are generally understood and well documented. For instance, the New York Times has reported on studies showing increases in heart disease (22%), stroke (37%), and cardiovascular death (2%) due to the consumption of fried food. New York Times (Jan. 22, 2021). A majority of the calories in fried food are contributed by fat, so reducing the fat content without reducing palatability could be a valuable strategy to improve the dietary habits of those unwilling to forgo fried food.

Driven by consumer dietary trends, there has been a surge in plant-based proteins in the food industry. This widespread consumer appeal has resulted in many supply options, including vegetarian and vegan solutions. It has been previously discovered that pea protein is capable of reducing fat absorption when topically applied to the surface of coated product prior to frying. However, it has been generally understood that solubilized pea protein was necessary in order to substantially reduce fat absorption. More specifically, it has been understood by persons skilled in the art that in order to achieve the desired result of reduced fat absorption, specific targeted pH ranges would be necessary. See, e.g., Process for Reducing Oil and Fat Content in Cooked Food with Pea Protein U.S. Pat. No. 9,028,905, Issued May 12, 2015, which is incorporated in its entirety by reference herein.

U.S. Pat. No. 9,028,905 discloses that pea protein can be used to reduce the overall fat content in cooked food, however, it further explained that the pea protein solution should be an acidic solution with a pH in the range of 2 to 3, or a basic solution with a pH range from 8 to 9, the ranges where pea protein conventionally exhibits excellent solubility. At that time, it was also disclosed and readily understood that it was not desirable to approach the isoelectric point, pH range of 4 to 6, where the pea protein would have reduced solubility. Contrary to these prior teachings, however, the inventors have unexpectedly discovered that pea protein compositions with a pH in the range of about 4 to about 6 are capable of achieving desirable reductions in fat absorption without compromising on the quality of the fried food. This discovery was surprising, particularly where persons of ordinary skill would understand that at the isoelectric point there is an equal amount of positive and negative charges along the protein molecule and the charged segments tend to interact with each other. This interaction of opposite charges within the protein molecule makes the overall protein molecule much less reactive, and in many cases the protein precipitates out of solution.

### SUMMARY OF THE INVENTION

The present invention relates to “fat blocking” compositions comprising pea protein, and optionally antioxidants and/or polysaccharides derived from mushrooms, which maintain the stability and quality of the fat block and the fried food. These compositions can be applied to various food substrates prior to frying in order to reduce the overall fat absorption when the food is cooked in fat or oil. Another aspect of the present invention relates to processes for preparing such compositions. Another aspect of the present invention relates to compositions comprising pea protein solutions, and pea protein blends, for instance pea protein mixtures that have been adjusted to have a pH in the range of about 4 to about 6. Another aspect of the present invention relates to methods for reducing the overall fat absorption when the food is cooked in oil or fat, while maintaining, and in some instances enhancing, desirable sensory characteristics of the cooked food.

Another aspect of the present invention relates to a process for coating uncooked food with the fat blocking compositions that contain pea protein, for instance pea protein mixtures with a pH in the range of about 4 to about 6, prior to cooking the food in oil or fat, including but not limited to dipping the food in the pea protein composition, spraying the pea protein composition on the food, or alternatively incorporating the pea protein composition into a mixture, such as batter or bread crumbs, used to coat the food prior to cooking the food with oil or fat.

### DETAILED DESCRIPTION OF THE FIGURES

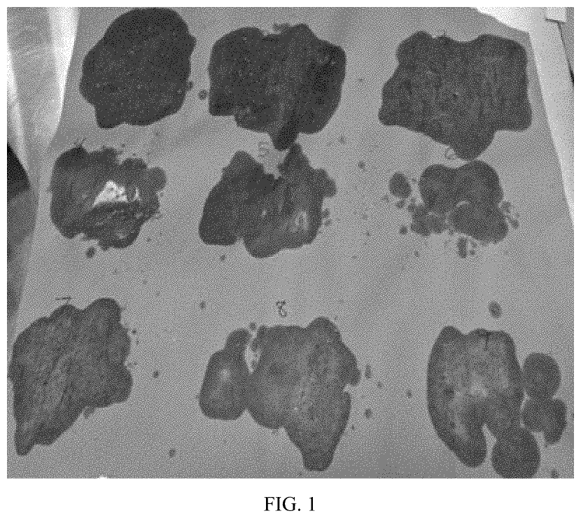

FIG. 1 depicts blotting paper from untreated mushrooms batches 1-9.

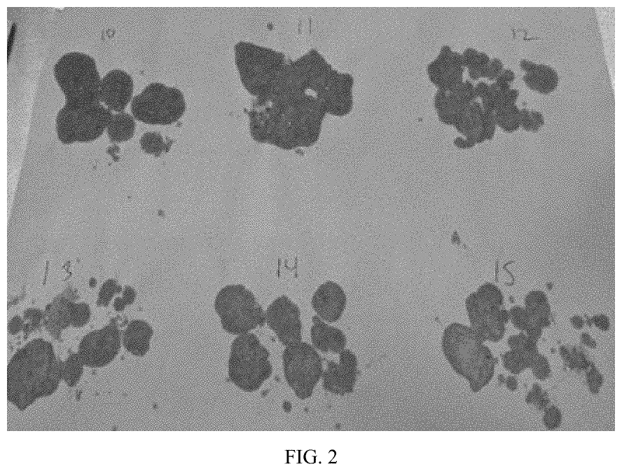

FIG. 2 depicts blotting paper from untreated mushrooms batches 10-15.

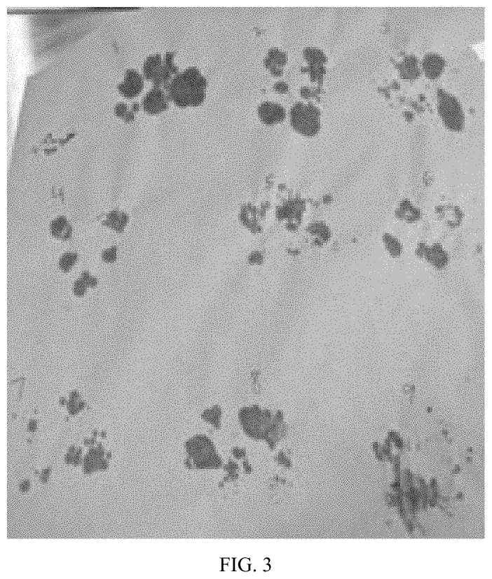

FIG. 3 depicts blotting paper from pea protein-dipped mushrooms batches 1-9.

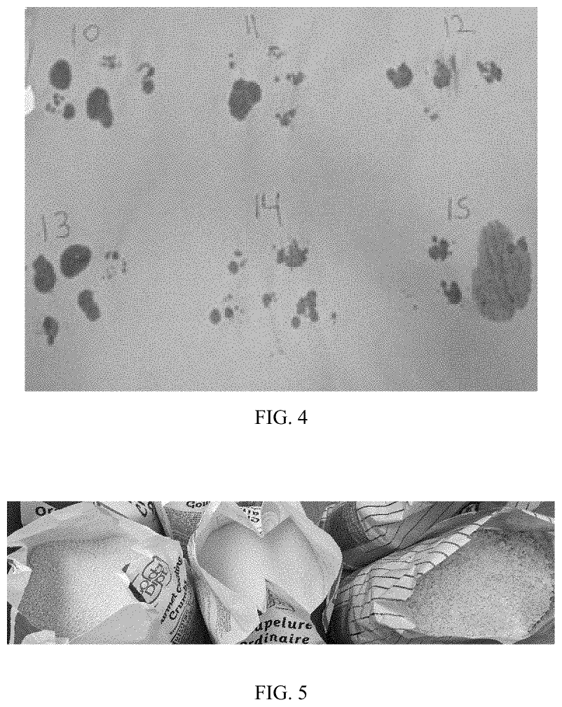

FIG. 4 depicts blotting paper from pea protein-dipped mushrooms batches 10-15.

FIG. 5 depicts bread crumbs used to coat the chicken tenders. Left to right: gourmet (extruded, chemically leavened), plain (yeast leavened), and toasted Japanese panko (yeast leavened)

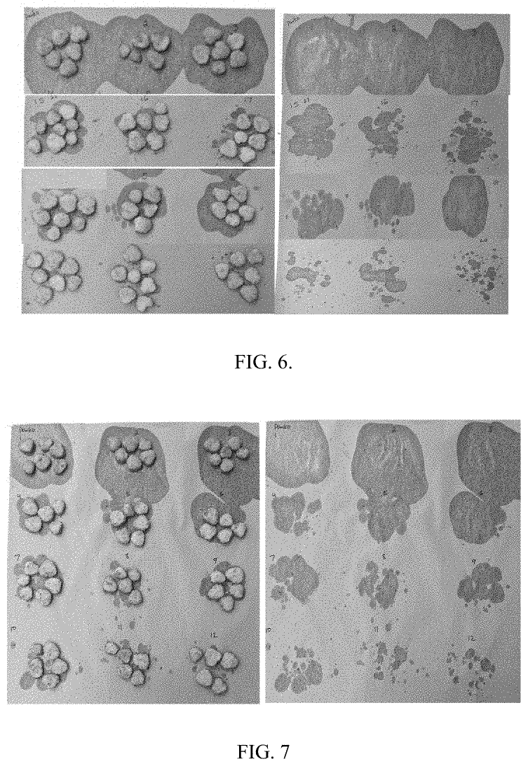

FIG. 6 shows on the Left: fried pickle chips with panko breading, replicate one. Top row: untreated, second row: 2% Proteus V Dry, third row: 4% Proteus V Dry, bottom row: 6% Proteus V Dry. Right: blotting paper from the treatments in the left photo.

FIG. 7 shows on the Left: fried pickle chips with panko breading, replicate two. Top row: untreated, second row: 2% Proteus V Dry, third row: 4% Proteus V dry, bottom row: 6% Proteus V Dry. Right: blotting paper from the treatments in the left photo.

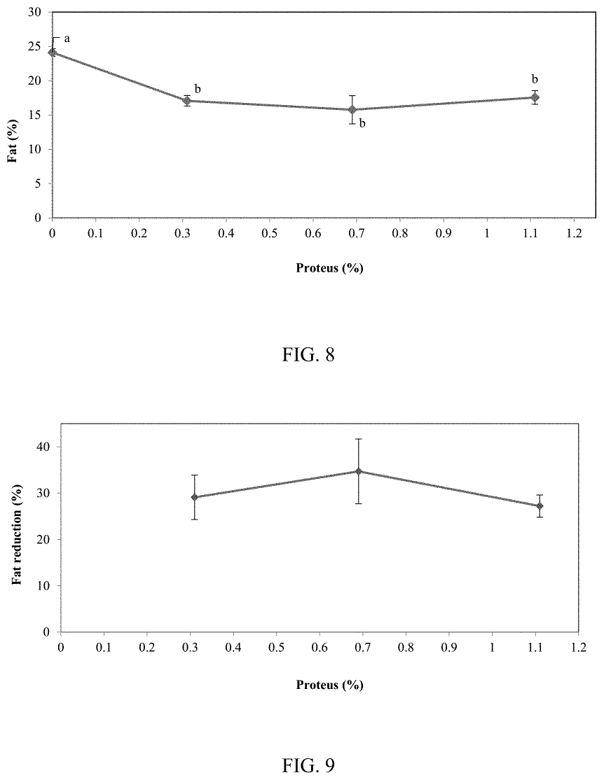

FIG. 8 depicts fat content of fried pickles coated in panko bread crumbs (n=2). Error bars represent ±SEM. Treatment results with different letters are significantly different (ρ<0.05).

FIG. 9 depicts fat content reduction of fried pickles coated in panko bread crumbs (n=2). Error bars represent ±SEM. There were no significant differences in fat reduction percentage between the treatments (ρ=0.4952).

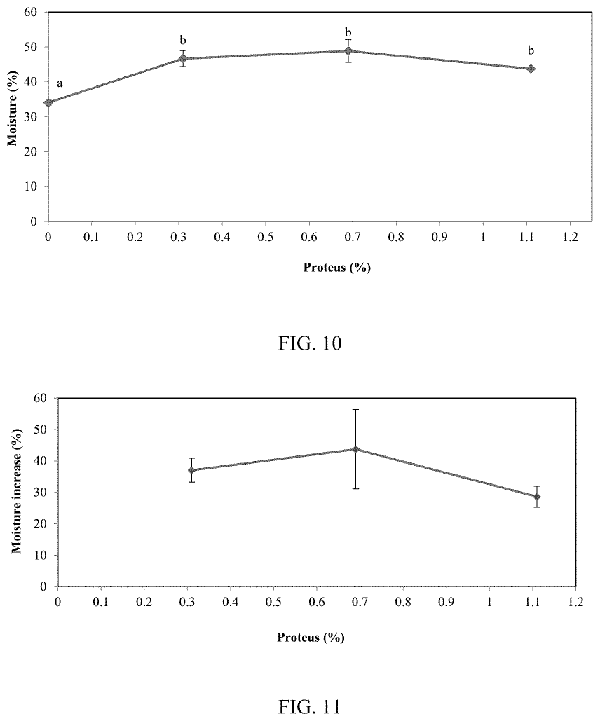

FIG. 10 depicts moisture content (%) of fried pickles coated in panko bread crumbs (n=2). Error bars represent ±SEM. Results with different letters are significantly different (ρ<0.05).

FIG. 11 depicts moisture content increase (%) of fried pickles coated in panko bread crumbs (n=2). Error bars represent ±SEM. There were no significant differences in moisture content increase between the treatments (ρ=0.3665).

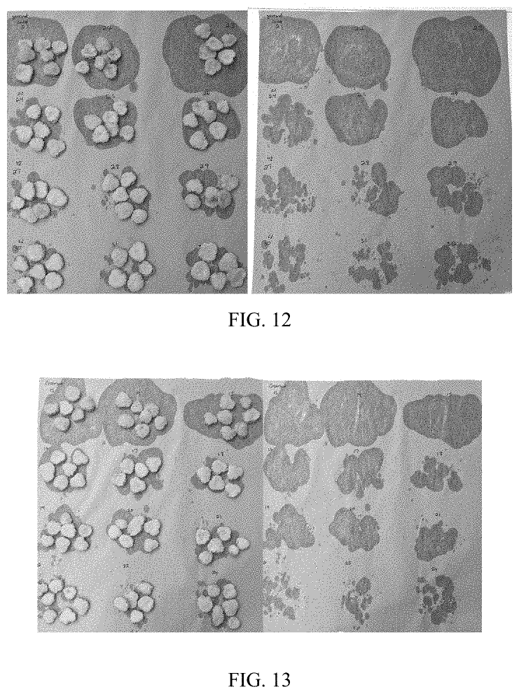

FIG. 12 shows on the Left: fried pickle chips with gourmet breading, replicate one. Top row: untreated, second row: 2% Proteus V Dry, third row: 4% Proteus V dry, bottom row: 6% Proteus V Dry. Right: blotting paper from the treatments in the left photo.

FIG. 13 shows on the Left: fried pickle chips with gourmet breading, replicate two. Top row: untreated, second row: 2% Proteus V Dry, third row: 4% Proteus V dry, bottom row: 6% Proteus V Dry. Right: blotting paper from the treatments in the left photo.

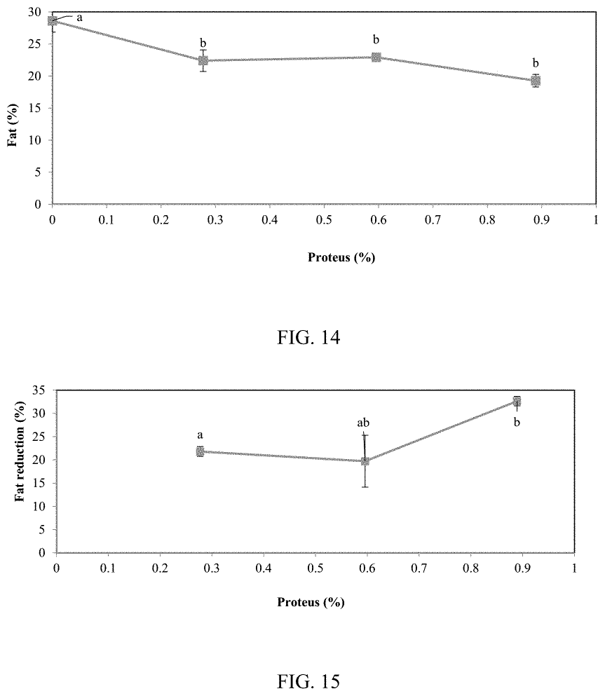

FIG. 14 depicts fat content of fried pickles coated in gourmet bread crumbs (n=2). Error bars represent ±SEM. Treatment results with different letters are significantly different (ρ<0.05).

FIG. 15 depicts fat content reduction of fried pickles coated in gourmet bread crumbs (n=2). Error bars represent ±SEM. Results with different letters are significantly different (ρ<0.05).

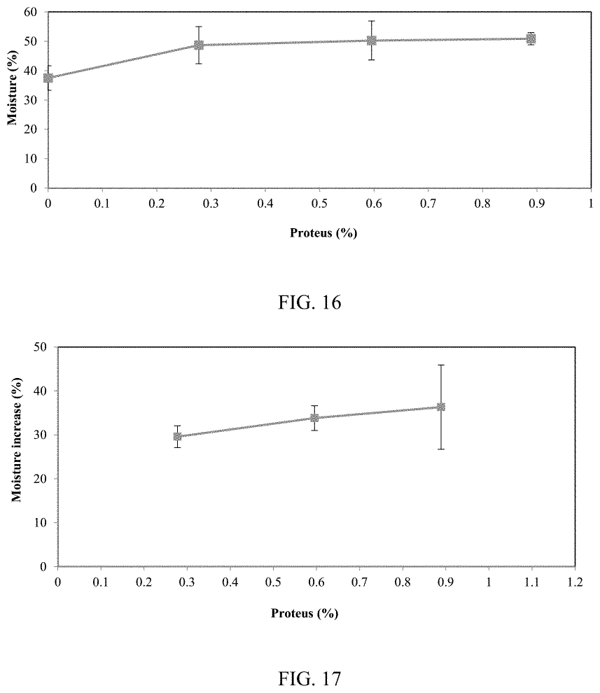

FIG. 16 depicts moisture content (%) of fried pickles coated in gourmet bread crumbs (n=2). Error bars represent ±SEM. There were no significant differences in moisture content between the treatments (ρ=0.2190).

FIG. 17 depicts moisture content increase (%) of fried pickles coated in gourmet bread crumbs (n=2). Error bars represent ±SEM. There were no significant differences in moisture content increase between the treatments (ρ=0.6478).

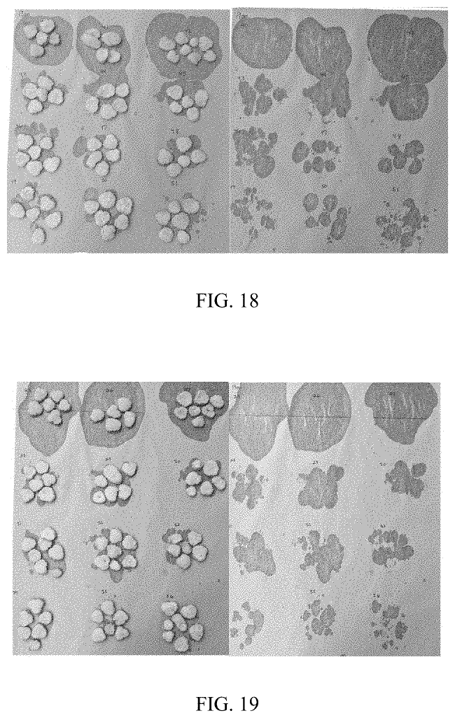

FIG. 18 shows on the Left: fried pickle chips with plain breading, replicate one. Top row: untreated, second row: 2% Proteus V Dry, third row: 4% Proteus V dry, bottom row: 6% Proteus V Dry. Right: blotting paper from the treatments in the left photo.

FIG. 19 shows on the Left: fried pickle chips with plain breading, replicate two. Top row: untreated, second row: 2% Proteus V Dry, third row: 4% Proteus V dry, bottom row: 6% Proteus V Dry. Right: blotting paper from the treatments in the left photo.

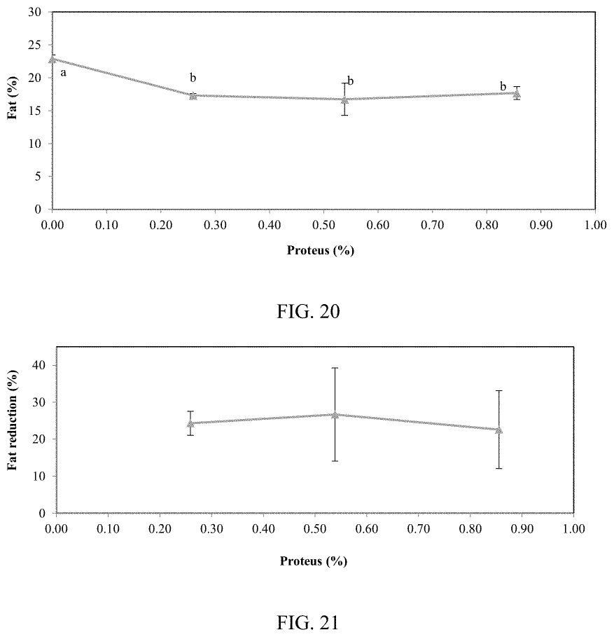

FIG. 20 depicts fat content of fried pickles coated in plain bread crumbs (n=2). Error bars represent ±SEM. Treatment results with different letters are significantly different (ρ<0.10).

FIG. 21 depicts fat content reduction of fried pickles coated in plain bread crumbs (n=2). Error bars represent ±SEM. There were no significant differences in fat reduction percentage between the treatments (ρ=0.9344).

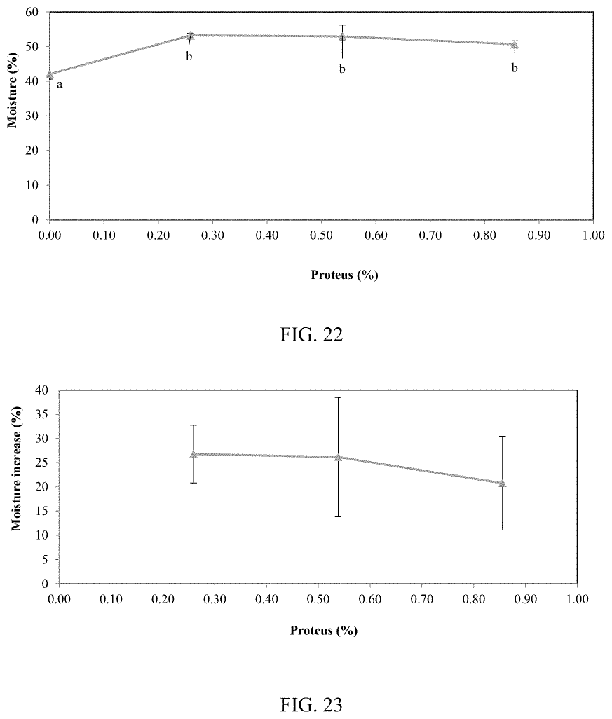

FIG. 22 depicts moisture content (%) of fried pickles coated in plain bread crumbs (n=2). Error bars represent ±SEM. Results with different letters are significantly different (ρ<0.05).

FIG. 23 depicts moisture content increase (%) of fried pickles coated in plain bread crumbs (n=2). Error bars represent ±SEM. There were no significant differences in moisture content increase between the treatments (ρ=0.8443).

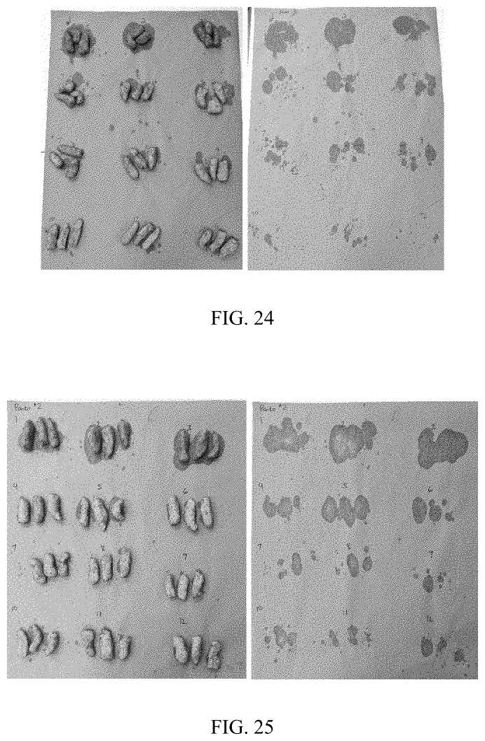

FIG. 24 shows on the Left: fried chicken with panko breading, replicate one. Top row: untreated, second row: 2% Proteus V Dry, third row: 4% Proteus V Dry, bottom row: 6% Proteus V Dry. Right: blotting paper from the treatments in the left photo.

FIG. 25 shows on the Left: fried chicken with panko breading, replicate two. Top row: untreated, second row: 2% Proteus V Dry, third row: 4% Proteus V dry, bottom row: 6% Proteus V Dry. Right: blotting paper from the treatments in the left photo.

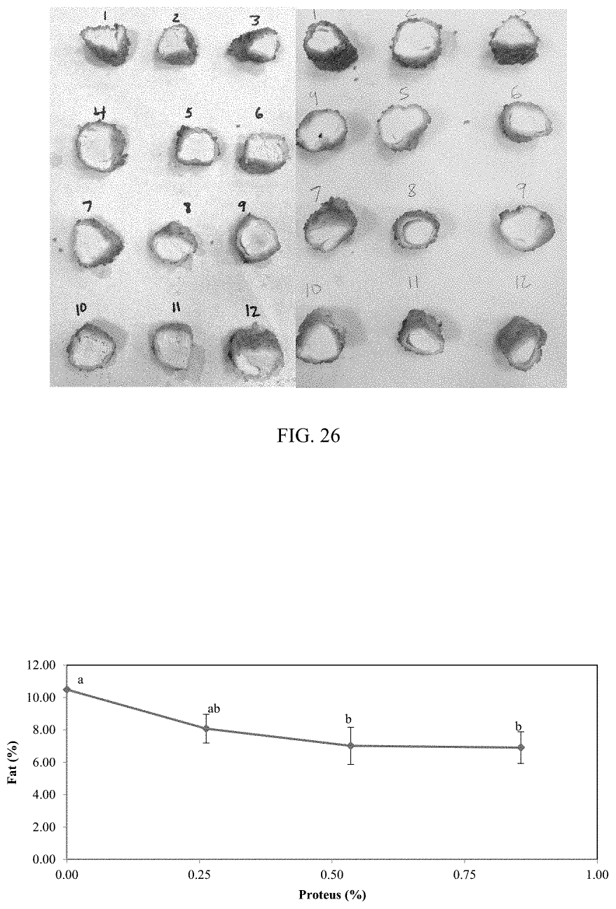

FIG. 26 shows on the Left: fried chicken with panko breading, replicate one. Top row: untreated, second row: 2% Proteus V Dry, third row: 4% Proteus V Dry, bottom row: 6% Proteus V Dry. Right: fried chicken with panko breading, replicate two. Top row: untreated, second row: 2% Proteus V Dry, third row: 4% Proteus V Dry, bottom row: 6% Proteus V Dry.

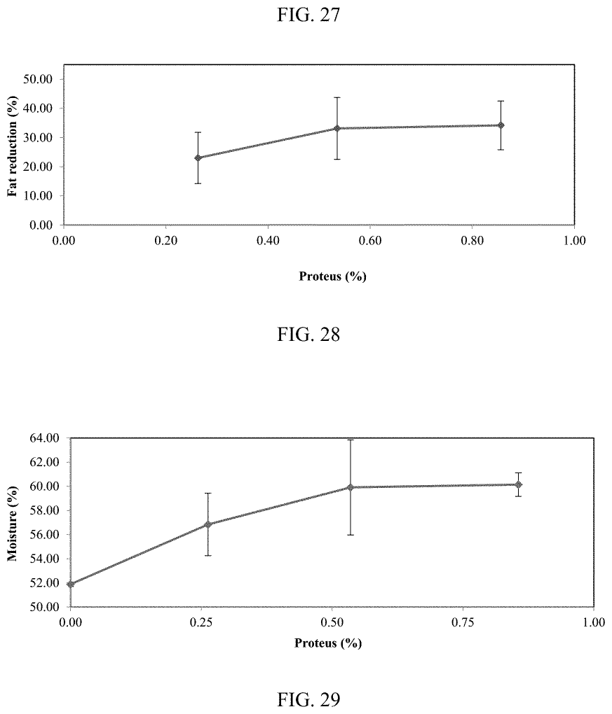

FIG. 27 depicts the fat content of fried chicken coated in panko breadcrumbs (n=2). Error bars represent ±SEM. Treatment results with different letters are significantly different (ρ<0.10).

FIG. 28 depicts the fat content reduction of fried chicken coated in panko breadcrumbs (n=2). Error bars represent ±SEM. There were no significant differences in the fat reduction percentage between the treatments (ρ=0.5715).

FIG. 29 depicts the moisture content (%) of fried chicken coated in panko breadcrumbs (n=2). Error bars represent ±SEM. There were no significant differences in moisture content between the treatments (ρ=0.1993).

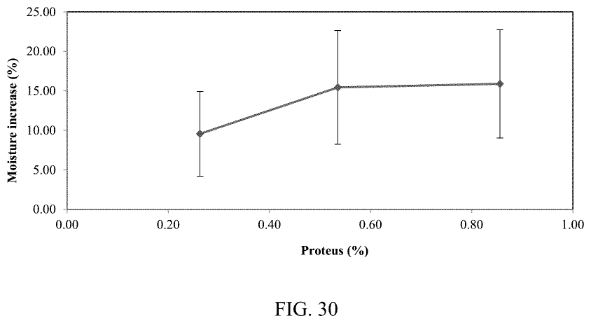

FIG. 30 depicts the moisture content increase (%) of fried chicken coated in panko breadcrumbs (n=2). Error bars represent ±SEM. There were no significant differences in moisture content increase between the treatments (ρ=0.6732).

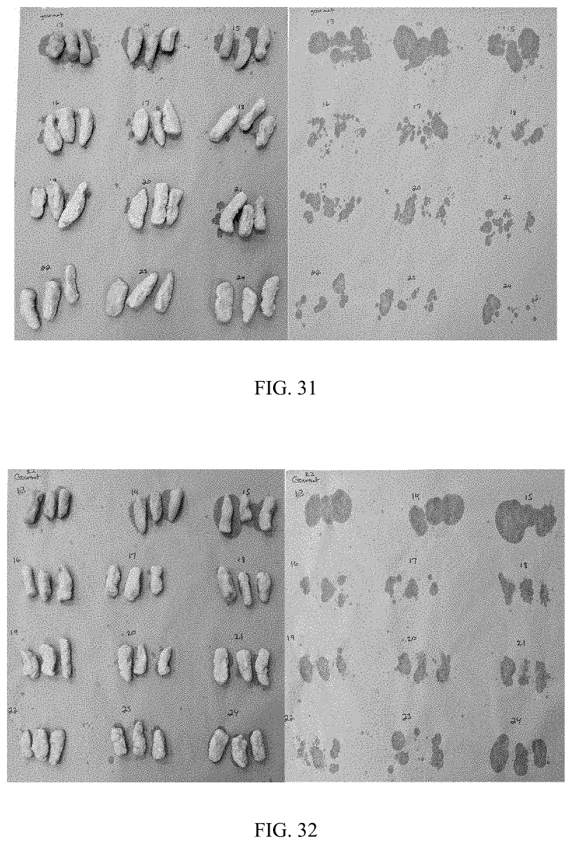

FIG. 31 shows on the Left: fried chicken with gourmet breading, replicate one. Top row: untreated, second row: 2% Proteus V Dry, third row: 4% Proteus V Dry, bottom row: 6% Proteus V Dry. Right: blotting paper from the treatments in the left photo.

FIG. 32 shows on the Left: fried chicken with gourmet breading, replicate two. Top row: untreated, second row: 2% Proteus V Dry, third row: 4% Proteus V Dry, bottom row: 6% Proteus V Dry. Right: blotting paper from the treatments in the left photo.

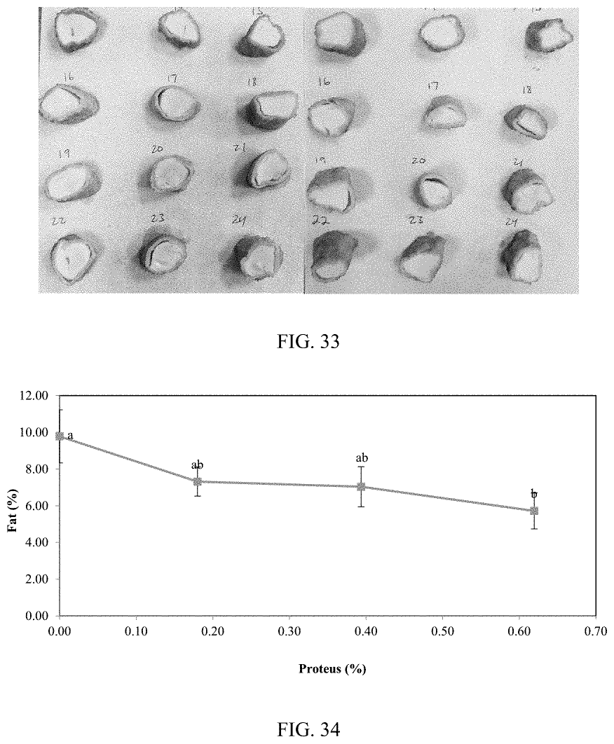

FIG. 33 shows on the Left: fried chicken with gourmet breading, replicate one. Top row: untreated, second row: 2% Proteus V Dry, third row: 4% Proteus V dry, bottom row: 6% Proteus V Dry. Right: fried chicken with gourmet breading, replicate two. Top row: untreated, second row: 2% Proteus V Dry, third row: 4% Proteus V dry, bottom row: 6% Proteus V Dry.

FIG. 34 depicts the fat content of fried chicken coated in gourmet breadcrumbs (n=2). Error bars represent ±SEM. Treatment results with different letters are significantly different (ρ<0.10).

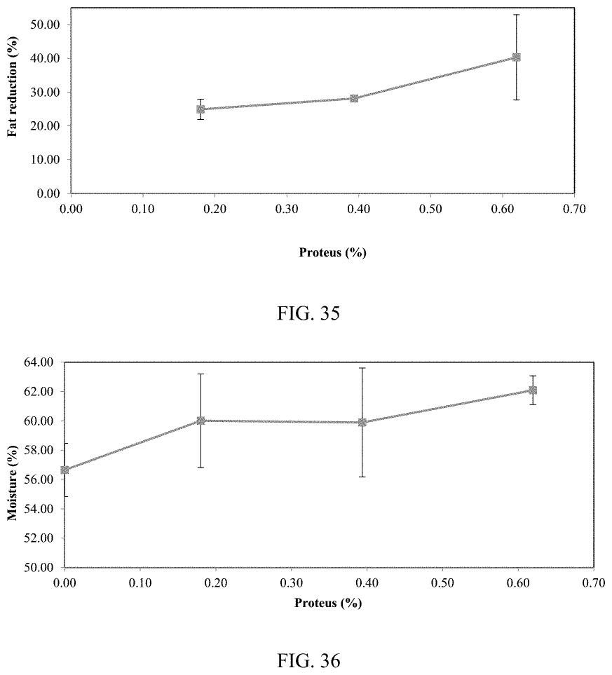

FIG. 35 depicts the fat content reduction of fried chicken coated in gourmet breadcrumbs (n=2). Error bars represent ±SEM. Results with different letters are significantly different (ρ<0.05). There were no significant differences in the fat reduction percentage between the treatments (ρ=0.3066).

FIG. 36 depicts the moisture content (%) of fried chicken coated in gourmet breadcrumbs (n=2). Error bars represent ±SEM. There were no significant differences in moisture content between the treatments (ρ=0.4441).

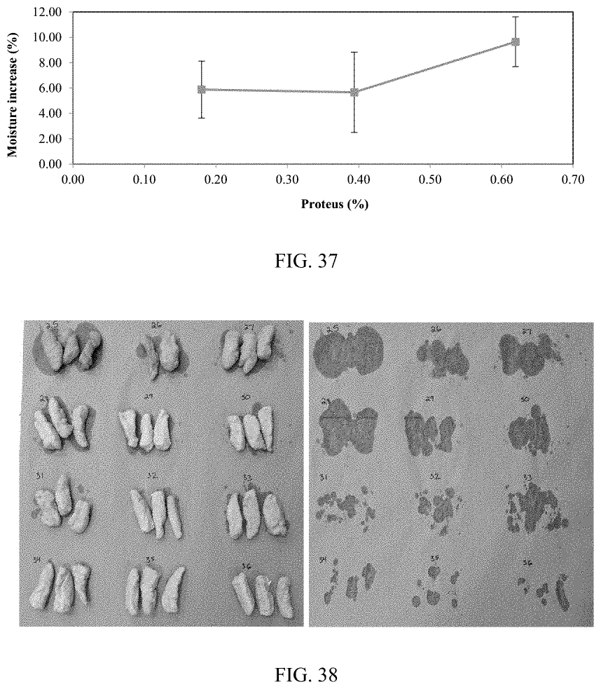

FIG. 37 depicts the moisture content increase (%) of fried chicken coated in gourmet breadcrumbs (n=2). Error bars represent ±SEM. There were no significant differences in moisture content increase between the treatments (ρ=0.4094).

FIG. 38 shows on the Left: fried chicken with plain breading, replicate one. Top row: untreated, second row: 2% Proteus V Dry, third row: 4% Proteus V Dry, bottom row: 6% Proteus V Dry. Right: blotting paper from the treatments in the left photo.

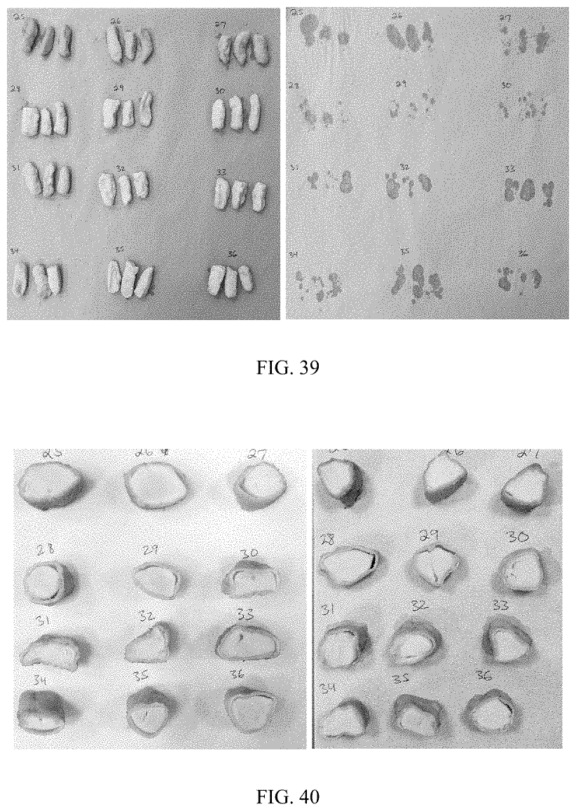

FIG. 39 shows on the Left: fried chicken with plain breading, replicate two. Top row: untreated, second row: 2% Proteus V Dry, third row: 4% Proteus V Dry, bottom row: 6% Proteus V Dry. Right: blotting paper from the treatments in the left photo.

FIG. 40 shows on the Left: fried chicken with plain breading, replicate one. Top row: untreated, second row: 2% Proteus V Dry, third row: 4% Proteus V dry, bottom row: 6% Proteus V Dry. Right: fried chicken with plain breading, replicate two. Top row: untreated, second row: 2% Proteus V Dry, third row: 4% Proteus V dry, bottom row: 6% Proteus V Dry.

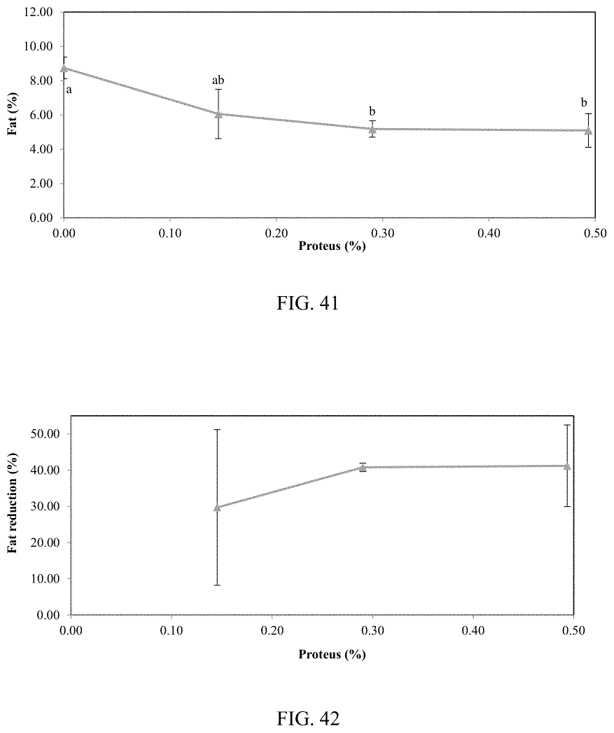

FIG. 41 depicts the fat content of fried chicken coated in plain breadcrumbs (n=2). Error bars represent ±SEM. Treatment results with different letters are significantly different (ρ<0.10).

FIG. 42 depicts the fat content reduction of fried chicken coated in plain breadcrumbs (n=2). Error bars represent ±SEM. There were no significant differences in fat content reduction between the treatments (ρ=0.7409).

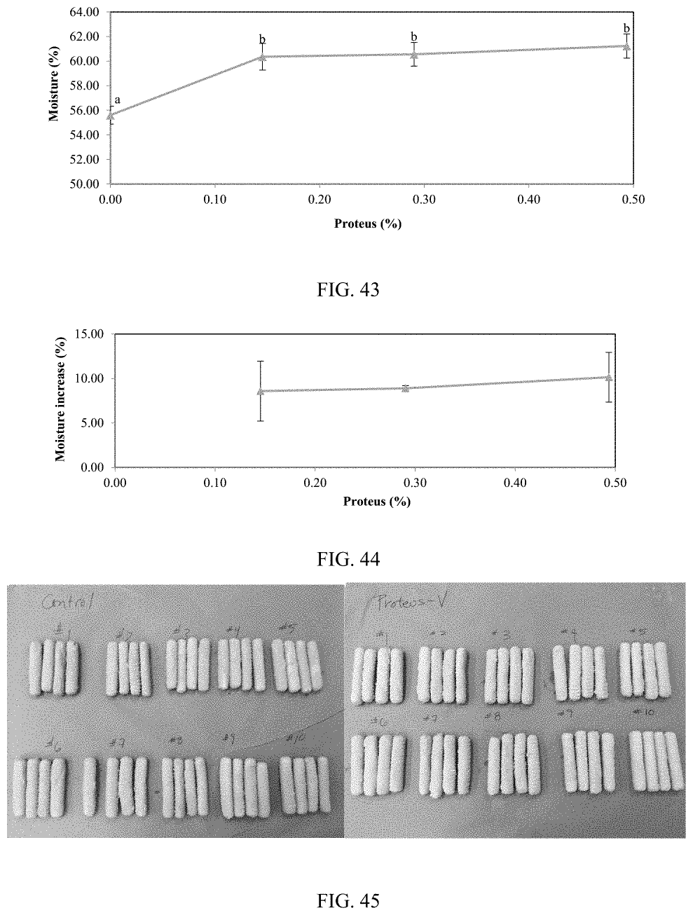

FIG. 43 depicts the moisture content (%) of fried chicken coated in plain breadcrumbs (n=2). Error bars represent ±SEM. Results with different letters are significantly different (ρ<0.05).

FIG. 44 depicts the moisture content increase (%) of fried chicken coated in plain breadcrumbs (n=2). Error bars represent ±SEM. There were no significant differences in the moisture content increase between the treatments (ρ=0.8566).

FIG. 45 shows the Control (left) and Proteus®-V (right) dipped par-fried mozzarella sticks Day 1 Trial

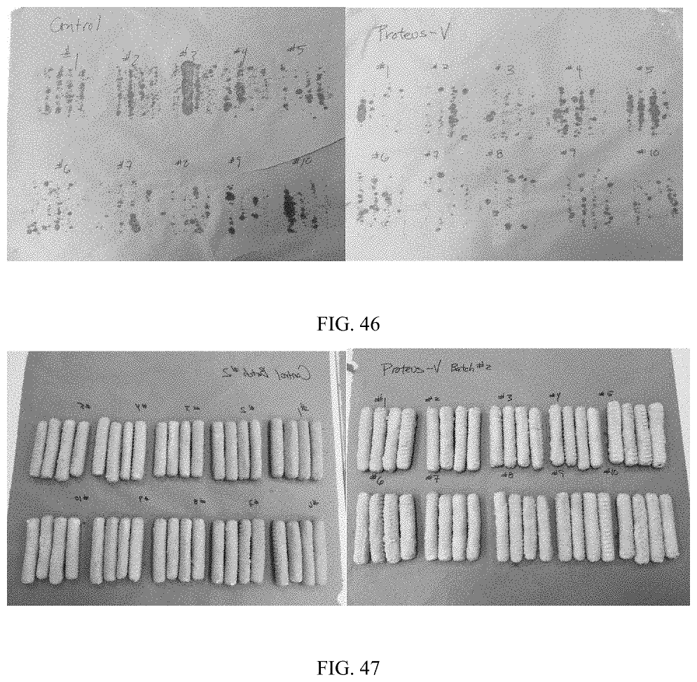

FIG. 46 shows the Control (left) Proteus®-V (right) dipped par-fried mozzarella sticks on blotting paper Day 1 Trial.

FIG. 47 shows the Control (left) and Proteus®-V (right) dipped par-fried mozzarella sticks Day 2 Trial.

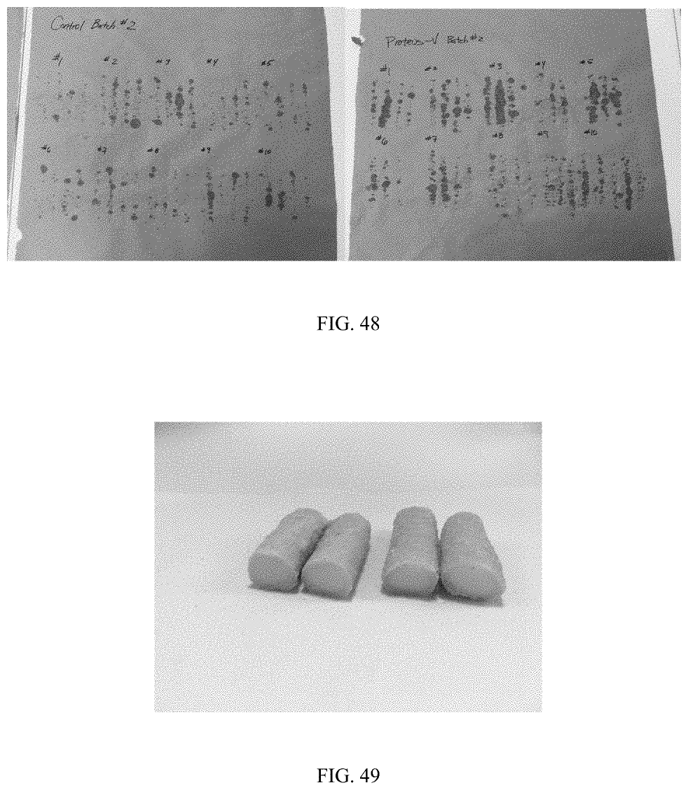

FIG. 48 shows the Control (left) Proteus®-V (right) dipped par-fried mozzarella sticks on blotting paper Day 2 Trial

FIG. 49 shows the diagonal cut view of Control (left) and Proteus®-V (right) par-fried mozzarella sticks.

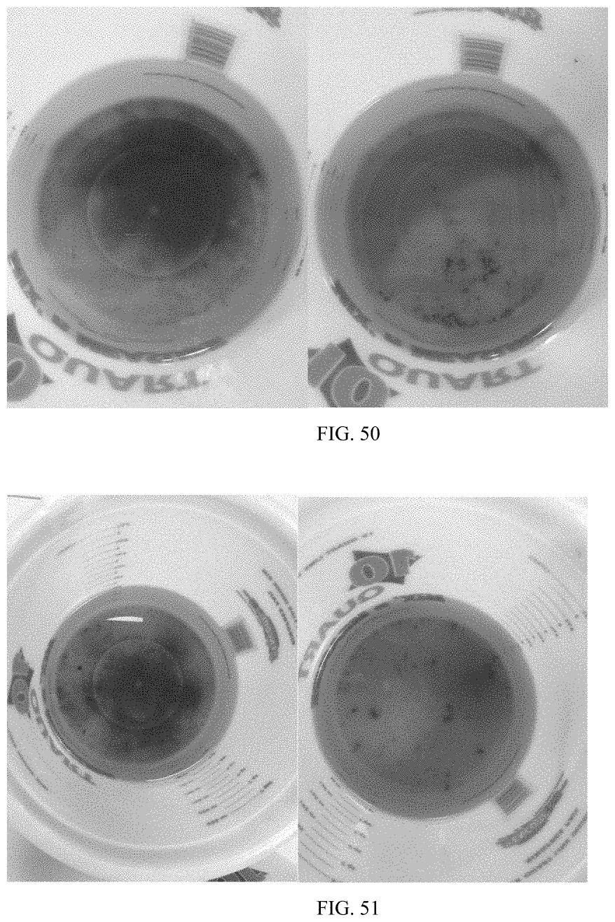

FIG. 50 depicts the oil after frying for Control (left) and Proteus®-V (right) mozzarellas sticks, Day 1 trials after 10 batches.

FIG. 51 depicts the oil after frying for Control (left) and Proteus®-V (right) mozzarellas sticks, Day 2 trials after 10 batches.

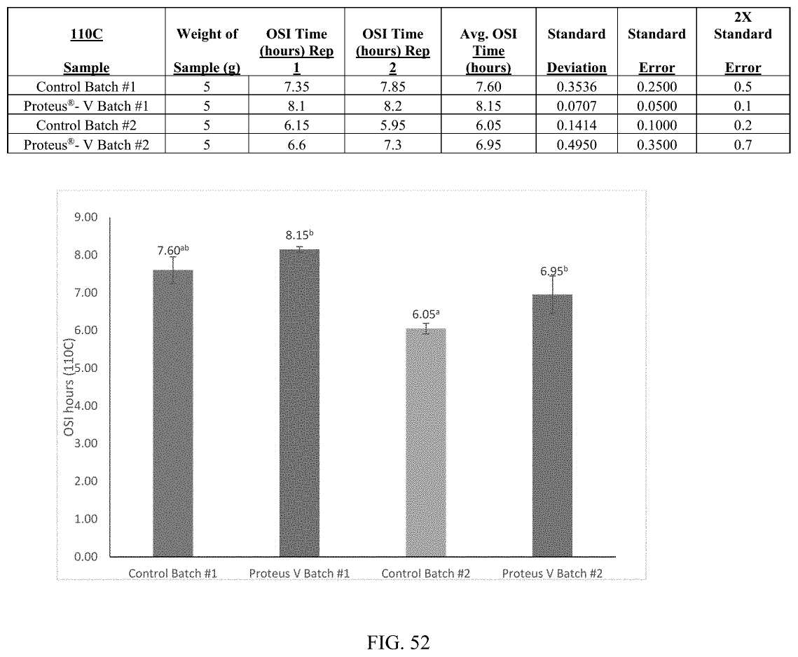

FIG. 52 shows the data and bar graph of Oxidative Stability Index (OSI) of frying oils from mozzarella stick experiments.

### DETAILED DESCRIPTION OF THE INVENTION

The present invention relates to “fat blocking” compositions comprising pea protein, and optionally an antioxidant, that can be applied to various food substrates prior to frying in order to reduce the overall fat absorption when fried. Another aspect of the present invention relates to the processes for preparing such compositions. Another aspect of the present invention relates to preparing fat blocking compositions that contain pea protein mixtures or in the pH range of about 4 to about 6, where the composition is capable of reducing the overall fat absorption when fried to a desirable level, while maintaining desirable sensory characteristics of the fried food.

According to at least one embodiment, the “fat blocking” composition contains pea protein, and optionally an antioxidant, applied to food, either through a pre-frying dip or a spraying step, where the composition is capable of reducing the overall fat absorption by at least 20% when it is applied to the food prior to cooking the food. In an alternative embodiment, the composition is incorporated into the batter or bread mixture used to coat the uncooked food prior to frying.

Another aspect of the present invention relates to a process for preparing the pea protein composition to have a pH between about 4 to about 6.

Another aspect of the present invention relates to methods for reducing the overall fat absorption by coating an uncooked food with a composition that contains pea protein, and optionally an antioxidant, prior to frying, where the amount of oil and/or fat absorbed by the food during cooking is substantially reduced, for instance by at least 20%, or at least 30% by weight when compared to a food that did not include the pea protein composition.

Processes for obtaining pea protein compositions are disclosed, for example in U.S. Patent Application No. 2008/0226810A1, published Sep. 18, 2008, which is incorporated in its entirety herein by reference.

According to at least one embodiment of the present invention, the pea protein solution is achieved by targeting the isoelectric point. This can be accomplished by adding an acid, such as citric acid, to adjust the pH to the range of about 4 to about 6. In certain embodiments, the pH is in the range of about 4.0 to about 5.5, while in other embodiments the pH is about 4.5 to about 4.8, and most preferably 4.5. Persons of ordinary skill in the art would recognize that other acids can be used to achieve the desired pH level, including but not limited to phosphoric acid, hydrochloric acid, or other organic acids, such as malic, lactic and tartaric acids.

The compositions of the present invention can be directly applied to the surface of a food substrate. In alternative embodiments, the dry pea protein composition or the aqueous pea protein solution is coated onto the surface of the food prior to cooking in oil or fat, for instance through dipping or spraying onto the food surface, or alternatively it is injected into and/or admixed with the batter or bread mixture that is applied to the surface of the uncooked food. In an alternative embodiment, the compositions are injected into and/or admixed with the uncooked food. Injection can be performed in myriad ways, such as with a syringe, by vacuum tumbling or by soaking the food in a pea protein solution. The dry pea protein composition or aqueous protein solution can be applied alone or in admixture with conventional food or nutritive additives such as breading or batter coatings, spice dry rubs, cracker meal, cornmeal or the like. By way of non-limiting example, the composition can be applied to uncooked food prior to cooking in oil or fat (i.e., frying), including vegetables such as an onion, cauliflower, broccoli, carrot, green bean, potato (e.g., French fries or chips), sugar snap peas, or corn. In at least one embodiment, the composition is applied to mushrooms. In alternative embodiments, the composition is applied to cheese, such as mozzarella cheese. In alternative embodiments, the composition is applied to pastry compositions, such as pastry for doughnuts, or pasta, such as noodles. The protein can be used on products that are par-fried (partially fried to set coating) or fully fried.

The protein can also be applied to non plant-based substrates, such as meat, fish or poultry. Representative suitable meats include ham, beef, lamb, pork, venison, veal, buffalo or the like; poultry such as chicken, mechanically deboned poultry meat, turkey, duck, a game bird or goose or the like, either in fillet form or in ground form. In addition, processed meat products which include animal muscle tissue, such as a sausage composition, a hot dog composition, emulsified product or the like can be coated, injected or mixed with the dry pea protein composition or the aqueous pea protein solution or a combination of these addition methods. Sausage and hot dog compositions include ground meat or fish, herbs such as sage, spices, sugar, pepper, salt and fillers such as dairy products that are well known in the art. Representative batter compositions include but are not limited to those comprising flour, egg and milk, which can include additional food such as cornmeal, cracker meal or dusting meals.

According to at least one embodiment of the present invention, the dry pea composition or the aqueous pea protein solution can be coated by immersion tumbling the uncooked food in the solution or in a marinade containing the aqueous protein solution in a container or tumbling or vacuum tumbling apparatus. The dry pea protein mixture, or aqueous pea protein solution also can contain flavors and spices such as salt, butter flavor or garlic flavor or the like. In alternative embodiments, the pea protein mixtures include additional spices to confer a savory or sweet flavor.

Persons of ordinary skill in the art will appreciate that multiple other sources of plant-based proteins could be amenable to this technology. Legumes, including pea protein was the first source of protein studied.

According to at least one embodiment, polysaccharides from mushroom sources can be optionally included in the plant-based protein composition. For instance, in at least one embodiment, the composition further comprises mushroom chitosan.

In additional embodiments, antioxidants can be optionally included in the plant-based protein composition. For instance, in at least one embodiment, the composition further comprises a blend of tocopherol, oil soluble green tea extract, rosemary extract, and/or blends thereof.

In alternative embodiments, the composition of the present invention includes naturally-derived extracts, such as rosemary extract, spearmint extract, green tea extract, acerola extract, tocopherols, and/or blends thereof.

As persons of ordinary skill in the art would appreciate, the term “a surface” as used herein generally refers to a surface of uncooked food which is positioned adjacent to a surface or surfaces of the uncooked food. For instance, a surface can be positioned 90 degrees from an adjacent surface or surfaces of the uncooked food. In addition, the term “a surface” can comprise the surface that connects or “sandwiched between” two adjacent surfaces. Most preferably, the entire surface of the uncooked food is coated with dry pea protein composition or aqueous pea protein solution, although in other embodiments most of the surface is coated. The uncooked food containing the pea protein then can be cooked at elevated temperature in oil and/or fat while substantially preventing absorption of oil and/or fat by the food being cooked.

Suitable oils and/or fats, including hydrogenated or nonhydrogenated oils which can be utilized to effect cooking of uncooked food are those conventionally used in cooking including lard, peanut oil, corn oil, vegetable oil, canola oil, olive oil, palm oil, coconut oil, sesame oil, sunflower oil, butter, mixtures thereof or the like.

Once the fat blocking composition has been added to the uncooked food, including but not limited to dipping the food in the pea protein composition, spraying the pea protein composition on the food, or alternatively incorporating the pea protein composition into a mixture, such as batter or bread crumbs, used to coat the food prior to cooking the food with oil or fat, the uncooked food can then be cooked with oil and/or fat in a conventional manner, such as by deep fat frying, pan frying or the like.

According to at least one embodiment of the present invention, the food prepared in accordance with the teachings of this disclosure contains between about 20% and about 40% less oil, for instance between about 20% and 25% less oil and/or fat by weight as compared to the same food free of the protein of this invention. According to at least one embodiment, the reduction in fat absorption was at least 25%, and more particularly it was about 30%. The amount of fat or oil needed to cook a given weight of a given type of food is correspondingly reduced.

According to at least one embodiment of the present invention, the food prepared in accordance with the teachings of this disclosure contains between about 6% and about 43% more moisture, for instance between about 10% and about 30%, and in additional embodiments between about 12% and about 20%, increased moisture by weight as compared to the same food free of the protein of this invention.

According to at least one embodiment, the pea protein compositions of the present invention are added to the surface of the food with an application rate ranging from about 0.1% to about 6% by weight, for instance between about 0.1 to about 2.5% by weight. In at least one embodiment, the composition is applied in an about between about 0.2% and about 1.5% by weight. In at least one embodiment, the food is dunked in the composition at an inclusion rate of about 6% by weight. Persons of ordinary skill in art will appreciate that the application technique, for instance applying the composition onto the food surface with a pre-frying dip, a spraying application, or alternatively by inclusion in a batter or other food coating, may influence the optimal inclusion rate.

In alternative embodiments, for instance when the amount is measured as a pick-up rate, the pea protein compositions of the present invention are added in an amount ranging from about 3% to about 15% by weight, and more specifically between about 4% to about 10% by weight.

The following examples illustrate the present invention and are not intended to be limiting.

### EXAMPLES

### Example 1

### Materials and Methods:

Chemicals and reagents. Reagents and chemicals that were used in this study were summarized in Table 1. The pea protein used in this study contains 50% protein, which was obtained from Kemin Nutrisurance (Des Moines, Iowa).

TABLE 1
Overview of Chemicals and Reagents.

| | RM # or | | |
|---|---|---|---|
| Material | Item # | Lot # | Supplier |
| Pea Protein | RM02135 | 2101117406 | Kemin Nutrisurance |
| | | | (Verona, MS) |
| Citric acid | RM16450 | N/A | |
| Cold Spring Water | N/A | N/A | Crystal Clear |
| Canola Oil | N/A | B.B | Hy-Vee (Des |
| | | Oct. 26, 2022 | Moines, IA) |
| Batter | B87874-1 | N/A | Newly Weds Foods |
| | | | (Horn Lake, MS) |
| Breading | A50092-1 | N/A | Newly Weds Foods |
| | | | (Horn Lake, MS) |
| Vidalia onions | N/A | N/A | Hy-Vee (Des |
| | | | Moines, IA) |
| FORTIUM ® | #017793 | 20201231-01 | KFT Am |
| TRLG 1727 | | | |

In the first study, the prototypes were tested without the addition of an antioxidant in the pea protein slurry. Fresh onions were peeled and cut into approximately ½ inch slices by hand. The cut onions were processed through a two-pass system that consisted of batter-pre-dust-batter-breading. The pre-dust was made by grinding the breading by hand for approximately one minute until a fine powder, by visual observation, was achieved. The batter was made by mixing the dry ingredients with water (30% dry/70% water) in a bowl by a whisk until a visually consistent batter was achieved.

The two-pass system used consisted of dipping the fresh cut onion rings into a well-mixed batter followed by a pre-dust and applying slight pressure to assure adhesion. The dusted onion rings were shaken lightly to remove loose pre-dust. The dusted onion rings were then returned into the bowl of batter and fully submerged. In next step, battered product was then placed into a bowl of breadcrumbs and tossed vigorously to assure full coverage. Excess breadcrumb was removed by slight shaking.

Next, the pea protein composition was slowly poured into cold spring water and mixed for approximately 30 seconds using a kitchen whisk. For each of the prototypes tested, the recipe is shown in Table 2 below.

TABLE 2
Formulas for pea protein water slurry prototypes.

| Prototype | Pea Protein, | Pea Protein, | Pea Protein, |
|---|---|---|---|
| Description | pH 6.6 | pH 4.5 | pH 3.6 |
| Pea Protein (%) | 4.0 | 4.0 | 4.0 |
| Citric acid (%) | 0 | 0.1510 | 0.3158 |
| Water (%) | 96.0 | 95.849 | 95.684 |

The concentration of pea protein was selected to match the concentration used in U.S. Pat. No. 9,028,905. Because the pea protein used in this experiment was 50% concentration strength, twice the amount (4%) was used. As outlined in Table 2, the compositions vary in the amount of citric acid and resulted in three different acidities.

The protein slurries were used as a “dip” for breaded onion rings. The purpose of this step was to coat the breading with the pea proteins that act as a “fat block” during the frying process. The breaded onion rings were dipped in the pea protein slurries for approximately one second before frying. Care was taken to ensure the same amount of pick-up from the pea protein slurries. The negative control was included, using breaded onion rings that were not run through the dipping process.

Next, the frying step occurred at 350° F. in fresh canola oil in a table-top fryer (Hamilton Beach). The coated onion rings were dropped into the frying oil for 1.5 minutes. Finished products was drained in the frying baskets, cooled to ambient temperature, and then frozen. Fat and moisture contents were analyzed using standard protocols for fried foods.

After the application of pea protein solution, it was determined that immediate transfer to the frying oil was found to produce the best product appearance.

TABLE 3
Percentage Protein Solution Pickup Prior to Deep-Fat Frying.

| | | | Pea protein | | |
|---|---|---|---|---|---|
| | Fresh | Breaded | coated | Fried | Percentage |
| | onion | onion | onion | onion | Protein |
| | rings | rings | rings | rings | Slurry |
| Sample No. | Wt. (g) | Wt. (g) | Wt. (g) | Wt. (g) | Pickup |
| 1 | 50.52 | 113.40 | 135.94 | 111.10 | 19.99% |
| 2 | 50.21 | 105.10 | 125.60 | 104.00 | 19.50% |
| 3 | 51.10 | 127.30 | 146.82 | 128.40 | 15.33% |

For the determination of impact of pH in the pea protein slurries, different amounts of citric acid were added to fixed amount of pea proteins in water as shown in Table 2. The weight changes of the onion rings over the preparation and frying processes were monitored and reported in Table 4.

Yield to green and cook yield of the fried onion rights were calculated using Equation 1 and Equation 2. There was a significant increase in yield to green and cook yield compared to the controls that contained no pea protein in their coating.

Yield to green=Weight of the fried food/Weight of the initial fresh onion rings
Equation 1. Calculation for yield to green of the fried onion rings.

Cook yield=Weight of the fried food/Weight of the coated and breaded onion rings
Equation 2. Calculation for cook yield of the fried onion rings.

TABLE 4
Pea protein pickup amount in breaded onion rings in Trial #1. Initial Wt.
represented the weight of fresh onion rings. Coated weight is the weight of
breaded and pea protein dipped onion rings. Fried weight reports the weight
of fried onion rings. Yield to GRN (green) and Cook yield are calculated using
Equation 1 and 2. Triplicates were performed for each treatment group.

| Treatment | Initial | Coated | Fried | Yield to | Cook |
|---|---|---|---|---|---|
| description | Wt. (g) | Wt. (g) | Wt. (g) | GRN (%) | Yield (%) |
| Control (No Dip) | | | | | |
| 1 | 46.94 | 95.70 | 83.01 | 176.84 | 86.74 |
| 2 | 45.64 | 101.32 | 88.60 | 194.13 | 87.45 |
| 3 | 48.77 | 104.21 | 88.35 | 181.16 | 84.78 |
| Average ± | | | | 184.04 ± 9.00^{a} | 86.32 ± 1.38^{a} |
| Standard | | | | | |
| deviation | | | | | |
| Pea Protein pH 6.6 | | | | | |
| 1 | 46.42 | 110.20 | 104.50 | 225.11 | 94.83 |
| 2 | 45.20 | 100.20 | 94.54 | 209.38 | 94.35 |
| 3 | 50.50 | 109.45 | 100.04 | 198.10 | 91.40 |
| Average ± | | | | 210.86 ± 13.57^{b} | 93.53 ± 1.86^{a, b} |
| Standard | | | | | |
| deviation | | | | | |
| Pea Protein pH 4.5 | | | | | |
| 1 | 50.66 | 99.97 | 95.20 | 187.90 | 95.23 |
| 2 | 48.82 | 104.50 | 101.69 | 208.30 | 97.31 |
| 3 | 50.30 | 113.25 | 111.80 | 222.20 | 98.72 |
| Average ± | | | | 206.13 ± 17.25^{a, b} | 97.09 ± 1.76^{b} |
| Standard | | | | | |
| deviation | | | | | |
| Pea Protein pH 3.6 | | | | | |
| 1 | 44.52 | 98.40 | 97.68 | 219.41 | 99.27 |
| 2 | 48.17 | 111.00 | 109.16 | 226.61 | 98.34 |
| 3 | 46.80 | 98.65 | 102.40 | 218.80 | 103.80 |
| Average ± | | | | 221.61 ± 4.34^{b, c} | 100.47 ± 2.92^{b, c} |
| Standard | | | | | |
| deviation | | | | | |

### Example 2

### Materials and Methods:

Chemicals and reagents. Reagents and chemicals that were used in this study are summarized in Table 1. The pea protein used in this study contains 50% protein, which was obtained from Kemin Nutrisurance (Des Moines, Iowa). In the second study, the prototypes were tested without the addition of an antioxidant in the pea protein slurry.

The same prototypes in Table 2 were treated with an antioxidant blend, FORTIUM TRLG 1727 (TRLG) (Kemin Industries, Des Moines, Iowa), at 0.864% (wt %). TRLG is a blend containing tocopherols, rosemary extract and lipid soluble green tea extract, and has been shown in previous studies to improve oxidative stability of fried foods. In the protein slurry, the proper amount of TRLG was transferred in and the mixture was agitated by the whisk for 1-2 min until the slurry was homogeneous by visual check. The same procedures for preparation of coated onion rings and frying were repeated. The fried foods were also analyzed for fat and moisture content, and were frozen for long-term storage studies. Statistics were performed using StatGraphics 18 software Multiple Range Test (ρ<0.05), level of significance.

FORTIUM TRLG 1727 was added to the protein water slurry for the potential protective effect during frozen storage of the fried foods. The weight change of the onion rings was also monitored in triplicates. The results are summarized in Table 5. Addition of antioxidants didn't impact the yields of the fried foods, which is desirable.

TABLE 5
Weight changes of processed onion rings in Trial #2 when the pea
protein dip was added with an antioxidant blend, FORTIUM TRLG 1727.
Initial Wt. represented the weight of fresh onion rings. Coated weight
is the weight of breaded and pea protein dipped onion rings. Fried
weight reports the weight of fried onion rings. Yield to GRN (green)
and Cook yield are calculated using Equation 1 and 2. Triplicates
were performed for each treatment group. AO = antioxidant

| Treatment | Initial | Coated | Fried | Yield to | Cook |
|---|---|---|---|---|---|
| groups | Wt. (g) | Wt. (g) | Wt.. (g) | GRN (%) | Yield (%) |
| pH 6.6, with AO | | | | | |
| 1 | 48.55 | 101.62 | 91.18 | 187.81 | 89.73 |
| 2 | 50.19 | 115.62 | 109.30 | 217.77 | 94.53 |
| 3 | 50.12 | 114.00 | 110.84 | 221.15 | 97.23 |
| Average ± | | | | 208.91 ± 18.35^{a, b} | 93.83 ± 3.80^{b, c} |
| Standard | | | | | |
| deviation | | | | | |
| pH 4.5, with AO | | | | | |
| 1 | 49.90 | 122.30 | 118.00 | 236.47 | 96.48 |
| 2 | 48.20 | 126.00 | 125.20 | 259.75 | 99.37 |
| 3 | 48.47 | 121.00 | 118.72 | 244.94 | 98.12 |
| Average ± | | | | 247.05 ± 11.78^{d} | 97.99 ± 1.44^{b, c} |
| Standard | | | | | |
| deviation | | | | | |
| pH 3.6, with AO | | | | | |
| 1 | 49.47 | 110.00 | 110.10 | 222.56 | 100.09 |
| 2 | 51.36 | 131.00 | 128.00 | 249.22 | 97.71 |
| 3 | 52.20 | 118.00 | 136.00 | 260.54 | 115.25 |
| Average ± | | | | 244.11 ± 19.50^{c, d} | 104.35 ± 9.52^{c} |
| Standard | | | | | |
| deviation | | | | | |

The fat and moisture contents in the fried onion rings are reported in Table 6.

TABLE 6
Fat and moisture content in the fried onion rings.
For each treatment group, triplicates were analyzed.
AO = Antioxidant dosed in the pea protein slurry.

| Treatment description | Fat (%) | Moisture (%) |
|---|---|---|
| Control (No Dip) | | |
| 1 | 23.30 | 37.4 |
| 2 | 18.79 | 44.1 |
| 3 | 25.97 | 34.4 |
| Average ± | 22.69 ± 3.63^{a} | 38.6 ± 5.0^{a} |
| Standard | | |
| deviation | | |
| pH 6.6 | | |
| 1 | 15.41 | 44.4 |
| 2 | 16.87 | 38.9 |
| 3 | 19.51 | 44.5 |
| Average ± | 17.26 ± 2.08^{b} | 42.6 ± 3.2^{a,b} |
| Standard | | |
| deviation | | |
| pH 4.5 | | |
| 1 | 17.42 | 47.9 |
| 2 | 19.69 | 43.8 |
| 3 | 15.84 | 44.5 |
| Average ± | 17.65 ± 1.94^{b} | 45.4 ± 2.2^{b} |
| Standard | | |
| deviation | | |
| Protein pH 3.6 | | |
| 1 | 15.59 | 45.6 |
| 2 | 15.38 | 44.9 |
| 3 | 17.63 | 49.8 |
| Average ± | 16.20 ± 1.24^{b} | 46.8 ± 2.7^{b} |
| Standard | | |
| deviation | | |
| pH 6.6, with AO | | |
| 1 | 19.69 | 40.1 |
| 2 | 21.09 | 43.8 |
| 3 | 18.07 | 44.0 |
| Average ± | 19.62 ± 1.51^{a,b} | 42.6 ± 2.2^{a,b} |
| Standard | | |
| deviation | | |
| pH 4.5, with AO | | |
| 1 | 14.38 | 44.6 |
| 2 | 16.76 | 43.5 |
| 3 | 17.55 | 44.1 |
| Average ± | 16.23 ± 1.65^{b} | 44.1 ± 0.6^{b} |
| Standard | | |
| deviation | | |
| pH 3.6, with AO | | |
| 1 | 12.78 | 45.2 |
| 2 | 17.26 | 43.2 |
| 3 | 18.35 | 40.6 |
| Average ± | 16.13 ± 2.95^{b} | 43.0 ± 2.3^{a,b} |
| Standard | | |
| deviation | | |

TABLE 7
Summary of Onion Ring Results Comparing Controls
to Topically Applied Pea Protein at Varying pH

| | | | Yield- | Cooked |
|---|---|---|---|---|
| | Fat | Moisture | To-Green | Yield |
| | Reduction | Increase | Increase | Increase |
| Product | vs | vs. | vs. | vs. |
| Description | Controls (%) | Controls (%) | Controls | Controls |
| pH 6.6 | 23.93 | 10.36 | 14.57 | 8.35 |
| pH 4.5 | 22.21 | 17.62 | 12.00 | 12.48 |
| pH 3.6 | 28.60 | 21.24 | 20.04 | 16.39 |
| pH 6.6 with AO | 13.53 | 10.36 | 13.51 | 8.70 |
| pH 4.5 with AO | 28.47 | 14.25 | 34.24 | 13.52 |
| pH 3.6 with AO | 28.91 | 11.40 | 32.64 | 20.89 |

The pea protein coated samples all had reduced fat content and increased moisture when compared to controls.

One advantage of the use of pea protein is the desirable increase in cook yield; with this in mind, the researchers observed that the acidified (at pH 3.6 and 4.5) products gave better results in this category. All of the pea protein dipped products met perceived industrial criteria for commercial adoption (i.e., 20% less fat, ≥5% cook yield, and no negative sensory impact) except for the pH 6.6 with antioxidant sample. Slight firmness, or a “shell” like coating, was detected in the pH 3.6 samples, which was less desirable compared to the pH 4.5 sample.

Additionally, the sensory observations demonstrated the onion rings coated with pea protein were found to have no off odor or taste; the texture was also juicy and the correct firmness. One participant in the sensory panel observed that the attribute that stood out was the “non-greasiness” of the pea coated onion rings. Other participants provided feedback that the treated onion rings being “the best they ever tasted.” The paper drain sheets also displayed substantially reduced oil drainage occurring on the pea coated product. Overall, the sensory panel pointed to a pea coated product having very similar taste and characteristics of an untreated control.

### Example 3

### Materials and Methods:

Mushroom frying procedure. The ingredients and raw materials used in this study are listed in Table 8. The batter (1 kg) was made by combining 30% batter mix and 70% cold spring water in a 4-quart stainless steel mixing bowl. The mixture was blended until homogenous using a handheld immersion blender (Kitchen Aid). Pre-dust was prepared by grinding the breading in a food processor (Cuisinart) for 30 seconds until it resembled a fine powder. The pea protein dip (Table 9) was prepared by combining 4% pea protein (50% protein content) with 96% cold spring water. The mixture was blended until homogenous using a handheld immersion blender (Kitchen Aid). The concentration of pea protein was selected based on the previous studies. Citric acid was added in small quantities until reaching the target pH of 4.50 (actual pH=4.48). The pH was measured using a handheld pH meter (Testo 206).

TABLE 8
Raw materials used in this study.

| | RM # or | | |
|---|---|---|---|
| Material | Item # | Lot # | Supplier |
| Pea Protein 50% | RM02135 | 2101117406 | Kemin Nutrisurance |
| | | | (Verona, MO) |
| Citric acid | RM16450 | N/A | Cargill |
| | | | (Minneapolis, MN) |
| Spring water | N/A | N/A | Crystal Clear |
| | | | (Des Moines, IA) |
| Canola oil | N/A | 051221-3627 | Fareway |
| | | | (Ankeny, IA) |
| Batter mix | B87874-1 | N/A | Newly Weds Foods |
| | | | (Horn Lake, MS) |
| Breading | A50092-1 | N/A | Newly Weds Foods |
| | | | (Horn Lake, MS) |
| White button | N/A | N/A | Fareway |
| mushrooms | | | (Ankeny, IA) |

TABLE 9
Acidified pea protein solution formula.

| Ingredient | Quantity (g) | Percentage (%) |
|---|---|---|
| Pea Protein | 40.0 | 3.99 |
| Citric acid | 2.30 | 0.25 |
| Water | 960 | 95.78 |

Three kg of canola oil was poured into two 9-cup, 1800 W digital deep fryers (Presto ProFry #05462). One fryer was dedicated for the untreated, and the other was used only for the protein dipped mushrooms. The fryer thermostats were set to preheat to 350° F. (176.7° C.). White button mushrooms were cleaned with a damp paper towel to remove soil, and the end of the stumps were removed with a knife so they were flush with the mushroom caps. The mushrooms were sorted into 29 groups of approximately 80 g, which was typically 4-5 mushrooms. An additional batch was only 50 g because it was unknown how much batter and breading would adhere to the mushrooms and meet the finished product weight target of 75-150 g. This batch weight target represented the optimum ratio of deep fried food:oil (1:20-1:40) necessary to prevent an excessive reduction in oil temperature upon addition of the food.

The untreated control mushrooms were prepared using a 3-step process: pre-dust, batter, and breading. The weight of the uncoated mushrooms was recorded as the green weight. Then the mushrooms from that batch were individually placed by hand into the bowl of pre-dust. They were removed from the pre-dust and lightly shaken to remove the excess. Next, they were lowered into the bowl of batter using a slotted spoon and removed after about 1 second. They were lightly shaken to remove the excess batter. Then the mushrooms were placed on top of the breading in the next bowl, and the breading was poured over the top and lightly pressed onto the mushrooms to encourage adhesion. The mushrooms were weighed to record the breaded weight. Then they were added to the fryer basket which was lowered into the oil and fried for 3 minutes until they were golden brown. The mushrooms were flipped after 1.5 minutes so that both surfaces had a uniform color. The fryer basket was raised from the oil, the mushrooms were drained for about 10 seconds, and then they were weighed to record the fried weight. They were transferred to the brown blotting paper (Uline 24″ kraft paper #S3575). After they were no longer steaming, they were removed from the blotting paper and transferred to a stainless steel baking sheet in the freezer. The protein-dip treated mushrooms were prepared using a 4-step process which included the 3 steps used for the untreated control plus the protein dip as the final step before frying. After the breaded weight was recorded, the mushrooms were lowered into the bowl of protein dip solution for 1 second using a slotted spoon. The dipped mushrooms were weighed to record the dipped weight, and then they were fried in the same manner as described for the untreated control.

Yield calculations. The breading pickup percentage was calculated using Equation 3. The pea protein coating uptake percentage was calculated using Equation 4. The yield to green weight percentage was calculated using Equation 5. Cook yield percentage for the untreated mushrooms was calculated using Equation 6, and the cook yield percentage for the protein-coated mushrooms was calculated using Equation 7. For each metric, the mean and standard deviation from the 15 batches were calculated using MS Excel. The oil remaining after the conclusion of frying was subtracted from the initial quantity of oil added to determine the amount of oil absorbed by the total quantity of fried food. This was used to determine the average quantity of oil absorbed by weight of the fried food. Only one replication of this experiment was performed.

$$Breading pickup calculation .$$

$$( \frac{breaded weight - green weight}{green weight} ) \times 100 = breading pickup ( \% ) \qquad Equation 3$$

$$Protein coating pickup calculation .$$

$$( \frac{coated weight - breaded weight}{breaded weight} ) \times 100 = coating pickup ( \% ) \qquad Equation 4$$

$$Yield to green weight calculation .$$

$$( \frac{fried weight}{green weight} ) \times 100 = yield to green ( \% ) \qquad Equation 5$$

$$Cook yield calculation for the untreated mushrooms .$$

$$( \frac{fried weight}{breaded weight} ) \times 100 = cook yield ( \% ) \qquad Equation 6$$

$$Cook yield calculation for the protein - dipped mushrooms .$$

$$( \frac{fried weight}{coated weight} ) \times 100 = cook yield ( \% ) \qquad Equation 7$$

Nutritional analysis. Two composite batches (1-7 and 8-15) were prepared for the untreated and protein-coated mushrooms. Each composite sample was ground in a food processor (Cuisinart) until homogenous, and analyzed for fat and moisture analysis following official methods appropriate for fried products.

The various measurements that were recorded for the 15 batches of untreated breaded mushrooms and the 15 batches of the protein-dipped breaded mushrooms are listed in Tables 10-11. The overall mean breading pickup percentage for the protein-dipped mushrooms was numerically higher (29.29%±3.67%) than the untreated mushrooms (25.59%±3.78%). The yield to green percentage for the protein-dipped mushrooms was numerically higher (120.58%±6.19%) than the untreated (109.14%±3.10%) which represents a 10.48% improvement. The cook yield for the protein-dipped mushrooms was numerically lower than the untreated mushrooms, but this made sense because 96% of the coating that was picked up by the mushrooms was water, so it evaporated during frying. This was why the yield to green percentage is a better measure of yield for this type of product rather than basing the yield off of the weight of the food immediately before and after frying.

TABLE 10
Metrics from the control mushroom frying experiment (without pea protein dip). Green Wt. was the weight
of the mushrooms. Breaded Wt. was recorded after the mushrooms were coated in pre-dust, batter, and
breading. Fried weight was recorded after the mushrooms were removed from the frying oil.

| Batch | Green | Breaded | Breading | Fried | Yield to | Cook |
|---|---|---|---|---|---|---|
| Number | Wt. (g) | Wt. (g) | Pickup (%) | Wt. (g) | Green (%) | Yield (%) |
| 1 | 51.54 | 62.29 | 20.86 | 56.52 | 109.66 | 90.74 |
| 2 | 89.68 | 107.53 | 19.90 | 95.69 | 106.70 | 88.99 |
| 3 | 83.01 | 97.87 | 17.90 | 88.18 | 106.23 | 90.10 |
| 4 | 84.4 | 107.72 | 27.63 | 93.5 | 110.78 | 86.80 |
| 5 | 82.84 | 104.38 | 26.00 | 87.05 | 105.08 | 83.40 |
| 6 | 81.61 | 105.07 | 28.75 | 91.72 | 112.39 | 87.29 |
| 7 | 85.92 | 105.79 | 23.13 | 94.04 | 109.45 | 88.89 |
| 8 | 85.22 | 107.83 | 26.53 | 92.61 | 108.67 | 85.89 |
| 9 | 85.24 | 108.87 | 27.72 | 93.71 | 109.94 | 86.08 |
| 10 | 81.67 | 104.92 | 28.47 | 86.33 | 105.71 | 82.28 |
| 11 | 85.22 | 108.83 | 27.70 | 96.8 | 113.59 | 88.95 |
| 12 | 80.05 | 99.24 | 23.97 | 84.04 | 104.98 | 84.68 |
| 13 | 75.92 | 99.72 | 31.35 | 84.51 | 111.31 | 84.75 |
| 14 | 83.07 | 107.14 | 28.98 | 95.48 | 114.94 | 89.12 |
| 15 | 79.71 | 99.64 | 25.00 | 85.85 | 107.70 | 86.16 |
| Average | 81.01 | 101.79 | 25.59 | 88.40 | 109.14 | 86.94 |
| Std. dev. | 8.76 | 11.55 | 3.78 | 9.83 | 3.10 | 2.51 |

TABLE 11
Metrics from the pea protein coated mushroom frying experiment. Green Wt. was the weight of the mushrooms. Breaded
Wt. was recorded after the mushrooms were coated in pre-dust, batter, and breading. Coated Wt. was recorded after the
pea protein solution dip. Fried weight was recorded after the mushrooms were removed from the frying oil.

| Batch | Green | Breaded | Breading | Coated | Coating | Fried | Yield to | Cook |
|---|---|---|---|---|---|---|---|---|
| Number | Wt. (g) | Wt. (g) | Pickup (%) | Wt. (g) | Pickup %) | Wt. (g) | Green (%) | Yield (%) |
| 1 | 80.83 | 102.47 | 26.77 | 117.28 | 14.45 | 90.67 | 112.17 | 77.31 |
| 2 | 86.47 | 108.04 | 24.95 | 123.69 | 14.49 | 94.4 | 109.17 | 76.32 |
| 3 | 84.14 | 110.70 | 31.57 | 123.91 | 11.93 | 103.2 | 122.65 | 83.29 |
| 4 | 87.4 | 109.83 | 25.66 | 120.85 | 10.03 | 100.98 | 115.54 | 83.56 |
| 5 | 80.36 | 102.02 | 26.95 | 113.10 | 10.86 | 93.61 | 116.49 | 82.77 |
| 6 | 85.06 | 112.16 | 31.86 | 125.76 | 12.13 | 103.65 | 121.86 | 82.42 |
| 7 | 84.92 | 116.39 | 37.06 | 129.21 | 11.01 | 112.38 | 132.34 | 86.97 |
| 8 | 83.31 | 106.4 | 27.72 | 118.41 | 11.29 | 101.67 | 122.04 | 85.86 |
| 9 | 78.41 | 101.69 | 29.69 | 112.75 | 10.88 | 99.57 | 126.99 | 88.31 |
| 10 | 82.60 | 111.15 | 34.56 | 123.08 | 10.73 | 102.55 | 124.15 | 83.32 |
| 11 | 81.37 | 103.04 | 26.63 | 113.71 | 10.36 | 95.41 | 117.25 | 83.91 |
| 12 | 74.74 | 98.16 | 31.34 | 108.47 | 10.50 | 93.05 | 124.50 | 85.78 |
| 13 | 77.95 | 98.55 | 26.43 | 109.47 | 11.08 | 90.78 | 116.46 | 82.93 |
| 14 | 86.06 | 113.99 | 32.45 | 126.49 | 10.97 | 109.8 | 127.59 | 86.81 |
| 15 | 74.22 | 93.32 | 25.73 | 103.71 | 11.13 | 88.73 | 119.55 | 85.56 |
| Average | 81.86 | 105.86 | 29.29 | 117.99 | 11.46 | 98.70 | 120.58 | 83.67 |
| Std. dev. | 4.11 | 6.60 | 3.67 | 7.55 | 1.33 | 7.06 | 6.19 | 3.30 |

The pea protein coating to reduced the oil absorbed during frying. This was measured quantitatively (Table 12) and revealed 21.9% less fat in the mushrooms that were dipped in the pea protein solution before frying compared to those fried without the protein treatment. These treated mushrooms also had 5.77% higher moisture than the untreated mushrooms. Based on the quantity of oil remaining after frying, the protein treatment resulted in 25% less oil used per unit weight of mushrooms used, which was 33% less oil used based on the weight of the finished fried mushrooms (Table 13).

TABLE 12
Average fat and moisture content of the fried mushrooms
and improvement over the control mushrooms.

| Sample | Fat | Moisture | Yield to | Cook |
|---|---|---|---|---|
| description | (%) | (%) | Green (%) | Yield (%) |
| Control | 11.75 ± 0.98 | 67.60 ± 2.69 | 109.14 ± 3.10 | 86.94 ± 2.51 |
| Pea protein | 9.26 ± 1.48 | 71.50 ± 5.37 | 120.58 ± 2.69 | 83.67 ± 3.30 |
| dipped | | | | |
| Improvement over | 21.19% | 5.77% | 10.48% | 3.27% |
| control | lower | higher | higher | lower |

TABLE 13
Oil usage based on quantity of mushrooms and finished product

| | Grams oil | Grams oil |
|---|---|---|
| | used/grams | used/grams |
| Sample description | green weight | fried food |
| Control | 0.20 | 0.18 |
| Pea protein dipped | 0.15 | 0.12 |
| Oil usage of protein | 25% less oil | 33% less oil |
| dipped vs. control | | |

Based on sensory observations, the pea protein treated mushrooms had a smoother surface appearance and firmer texture than the untreated mushrooms. Sensory testing revealed that coated mushrooms had a crisper texture, less greasy residue during chewing, and less oil remaining on one's fingers after touching the mushrooms. Furthermore, the size of oil residue remaining on the untreated mushroom blotting paper was considerably larger (FIGS. 1-2) than that of the protein coated mushrooms (FIGS. 3-4).

Overall, the acidified pea protein surface treatment reduced the fat content of the breaded mushrooms by 21%, and it increased the yield to green weight by 10.5%. There was less greasy residue left on the blotting paper and improved sensory quality based on comments of reduced greasy mouthfeel and crisper texture. Reduced oil usage (33%) per weight of fried food translates to lower raw material costs which would offset the cost of the protein coating.

In summary, the pea protein coated mushrooms had lower fat, higher moisture, and higher yield to green percentage compared to the control mushrooms. The reduced oil usage would offset at least a portion of the product cost, and the improved sensory characteristics would improve consumer appeal. The film-forming characteristics of the pea protein could be optimized based on the needs of the fried material, so the dip solution could be more highly concentrated for foods like mozzarella sticks that benefit from a harder shell, compared to battered tempura style vegetables that should have only a light crunchy coating with low residual oil. The “vegetable protein” labeling is another benefit for this product because many fried foods already contain vegetable proteins.

### Example 4

### Materials and Methods:

The ingredients and raw materials used in this study are listed in Table 14. The researchers identified three commonly used bread crumb types of interest for further study, including Japanese-style panko bread crumbs (crustless yeast leavened wheat bread), plain bread crumbs (yeast leavened wheat bread), and gourmet bread crumbs (chemically leavened, extruded) (FIG. 5). Each breading type was conducted as a separate experiment, and each was replicated twice. Fresh frying oil, batter, and dipping solutions were prepared for the 15 frying batches conducted for each breading type. Batter (300 g) was made by combining 30% batter mix and 70% cold spring water in a mixing bowl. The mixture was blended until homogenous using a handheld immersion blender (Kitchen Aid). Pre-dust was prepared by grinding the respective type of breading in a food processor (Cuisinart) for 30 seconds until it resembled a fine powder. Pre-frying dipping treatments (200 g, Table 15) were prepared to evaluate the fat-blocking ability of various levels of Proteus® V Dry (0%, 2%, 4%, and 6%), which is a combination of pea protein and lentil protein acidified to pH 4.50. Proteus V Dry and water were blended until homogenous using an immersion blender.

TABLE 14
Ingredients used in this study.

| Material | Item # | Lot # | Supplier |
|---|---|---|---|
| Proteus | 018246 | 20220201 | Kemin Food |
| V Dry | | | Technologies |
| | | | sampling |
| Spring | N/A | N/A | Crystal Clear |
| water | | | (Des Moines, IA) |
| Canola oil | N/A | 120621- | Fareway |
| replicate 1 | | 7142 | (Ankeny, IA) |
| Canola oil | N/A | 122721- | Fareway |
| replicate 2 | | 8336 | (Ankeny, IA) |
| Golden Dipt | 103GD700121 | N/A | Kerry Ingredients via |
| pre-dip | | | webstaurantstore.com |
| batter mix | | | |
| Golden Dipt | 104GD0048707 | N/A | Kerry Ingredients via |
| plain bread | | | webstaurantstore.com |
| crumbs | | | |
| Golden Dipt | 104GD4301707 | N/A | Kerry Ingredients via |
| gourmet bread | | | webstaurantstore.com |
| crumbs | | | |
| Panko Japanese | 13705010 | N/A | Kikkoman USA via |
| style toasted | | | webstaurantstore.com |
| bread crumbs | | | |
| Vlasic dill | N/A | N/A | Fareway |
| hamburger | | | (Ankeny, IA) |
| pickle chips | | | |

TABLE 15
Dipping treatments for each breading type
Description

Untreated control - no dip. Three batches for
break-in, three batches for experiment.
2% Proteus V Dry - three batches
4% Proteus V Dry - three batches
6% Proteus V Dry - three batches

Canola oil (2500 g) was poured into a 9-cup, 1800 W digital deep fryer (Presto ProFry #05462). The thermostat was set to preheat to 375° F. (190.5° C.). Jarred dill hamburger chips were drained using a wire strainer and blotted between layers of paper towels to remove excess surface moisture. The pickles were divided into 15 batches with a target weight of roughly 30-40 g. Based on prior studies, this batch weight target represented the optimum ratio of deep fried food to oil (1:20-1:40) to prevent an excessive reduction in oil temperature upon addition of the food. The weight of the uncoated pickles was recorded as the green weight. Three batches of pickles were stored at room temperature while they were battered, breaded, and fried, and the remaining batches were covered with plastic cling wrap and refrigerated until it was time to coat and fry them. For the first step of the coating process, the pickles for each batch were placed into the bowl of pre-dust and tossed. They were removed from the pre-dust and lightly shaken to remove the excess. The dusted pickles were then dipped into the bowl of batter and fully submerged. Next, the battered product was placed into a bowl of bread crumbs and tossed vigorously to assure full coverage. The pickles were gently shaken to remove excess bread crumb. Six batches of breaded pickles were not dipped in the protein bath before frying, but the remaining nine batches were dipped in the respective protein solutions immediately before frying. The pickles were lowered into the bowl of protein dip solution for 1 second using a slotted spoon, and then they were weighed to record the dipped weight.

Three batches of breaded but undipped pickles were fried to condition the oil and confirm the frying time. These batches were discarded after frying. The pickles were added to the fryer basket which was lowered into the oil and fried for 1.5 minutes until they were golden brown. The fryer basket was raised from the oil, the pickles were drained for about 10 seconds, and then they were weighed to record the fried weight. Two pickles from each batch were immediately placed into a sterile polyethylene bag with a fold-down wire closure (Fisher Scientific #14-955-176). The bag was closed and placed on an aluminum baking sheet in the freezer. The remaining pickles were spread out on brown blotting paper (Uline 24″ kraft paper #S3575) where they remained until they were cool to the touch.

Yield calculations. The breading pickup percentage was calculated using Equation 8. The Proteus V Dry coating uptake percentage was calculated using Equation 9. The actual percentage of Proteus V Dry delivered to the pickles was calculated using Equation 10. The yield to green weight percentage was calculated using Equation 11. Cook yield percentage for the untreated pickles was calculated using Equation 12, and the cook yield percentage for the protein-coated pickles was calculated using Equation 13. For each breading type, two replications were performed, three weeks apart.

$$Breading pickup calculation .$$

$$( \frac{breaded weight - green weight}{green weight} ) \times 100 = breading pickup ( \% ) \qquad Equation 8$$

$$Protein coating pickup calculation .$$

$$( \frac{coated weight - breaded weight}{breaded weight} ) \times 100 = coating pickup ( \% ) \qquad Equation 9$$

$$Actual Proteus V Dry delivered to the pickles .$$

$$Proteus V Dry coating pickup ( \% ) \times Proteus V Dry concentration ( \% ) in dipping solution = Proteus V Dry ( \% ) delivered to the pickles \qquad Equation 10$$

$$Yield to green weight calculation .$$

$$( \frac{fried weight}{green weight} ) \times 100 = yield to green ( \% ) \qquad Equation 11$$

$$Cook yield calculation for the untreated pickles .$$

$$( \frac{fried weight}{breaded weight} ) \times 100 = cook yield ( \% ) \qquad Equation 12$$

$$Cook yield calculation for the protein - dipped pickles .$$

$$( \frac{fried weight}{coated weight} ) \times 100 = cook yield ( \% ) \qquad Equation 13$$

Nutritional analysis. The two frozen pickles from each treatment batch were ground in a coffee grinder until homogenous. The moisture content of each batch was analyzed using the CEM Smart 6 Microwave+Infrared Moisture and Solids Analyzer, and then the sample was transferred to the Oracle Rapid NMR Fat Analyzer (CEM Corporation, Matthews, N.C.) to measure the fat content.

Statistical analysis. Within each breading type, fat, moisture, and cook yield values were subjected to one-way analysis of variance (ANOVA) based on treatment using the STATGRAPHICS® Centurion 18 software package⁶. When the ANOVA was significant (ρ<0.05), differences between the treatments were assessed using Fisher's least significant differences.

Results and Analysis. The results are summarized in Tables 16-24.

TABLE 16
Metrics from the first replicate of the panko breadcrumb dose response study. Green Wt. was the weight of the pickles.
Breaded Wt. was recorded after the pickles were coated in pre-dust, batter, and breading. Coated Wt. was recorded after
the plant protein solution dip. Fried weight was recorded after the breaded pickles were removed from the frying oil.

| | Green | Breaded | Breading | Coated | Coating | Fried | Yield to | Cook |
|---|---|---|---|---|---|---|---|---|
| Treatment | Wt. (g) | Wt. (g) | Pickup (%) | Wt. (g) | Pickup %) | Wt. (g) | Green (%) | Yield (%) |
| Untreated | 41.21 | 77.81 | 88.81 | | | 68.92 | 167.24 | 88.57 |
| Untreated | 33.60 | 62.11 | 84.85 | | | 51.54 | 153.39 | 82.98 |
| Untreated | 34.32 | 65.17 | 89.89 | | | 56.29 | 164.02 | 86.37 |
| 2% dip | 29.54 | 56.15 | 90.08 | 64.92 | 15.62 | 47.63 | 161.24 | 73.37 |
| 2% dip | 29.79 | 60.00 | 101.41 | 69.68 | 16.13 | 52.41 | 175.93 | 75.22 |
| 2% dip | 31.28 | 62.43 | 99.58 | 71.13 | 13.94 | 51.85 | 165.76 | 72.89 |
| 4% dip | 33.38 | 63.41 | 89.96 | 74.28 | 17.14 | 56.75 | 170.01 | 76.40 |
| 4% dip | 31.51 | 57.96 | 83.94 | 65.79 | 13.51 | 49.07 | 155.73 | 74.59 |
| 4% dip | 29.70 | 53.56 | 80.34 | 62.00 | 15.76 | 47.31 | 159.29 | 76.31 |
| 6% dip | 30.86 | 64.56 | 109.20 | 77.48 | 20.01 | 58.68 | 190.15 | 75.74 |
| 6% dip | 31.13 | 64.41 | 106.91 | 75.87 | 17.79 | 58.79 | 188.85 | 77.49 |
| 6% dip | 30.66 | 61.24 | 99.74 | 72.58 | 18.52 | 56.25 | 183.46 | 77.50 |

TABLE 17
Metrics from the second replicate of the panko breadcrumb dose response study.
Green Wt. was the weight of the pickles. Breaded Wt. was recorded after the
pickles were coated in pre-dust, batter, and breading. Coated Wt.
was recorded after the plant protein solution dip. Fried weight
was recorded after the breaded pickles were removed from the frying oil.

| | | | | | | | Yield | |
|---|---|---|---|---|---|---|---|---|
| | | | Breading | | Coating | | to | Cook |
| | Green | Breaded | Pickup | Coated | Pickup | Fried | Green | Yield |
| Treatment | Wt. (g) | Wt. (g) | (%) | Wt. (g) | %) | Wt. (g) | (%) | (%) |
| Untreated | 31.51 | 53.94 | 71.18 | | | 43.85 | 139.16 | 81.29 |
| Untreated | 30.54 | 52.5 | 71.91 | | | 43.16 | 141.32 | 82.21 |
| Untreated | 32.41 | 53.51 | 65.10 | | | 42.84 | 132.18 | 80.06 |
| 2% dip | 31.51 | 55.53 | 76.23 | 64.37 | 15.92 | 44.80 | 142.18 | 69.60 |
| 2% dip | 30.45 | 53.69 | 76.32 | 61.92 | 15.33 | 43.77 | 143.74 | 70.69 |
| 2% dip | 31.63 | 54.54 | 72.43 | 62.75 | 15.05 | 45.30 | 143.22 | 72.19 |
| 4% dip | 31.79 | 57.71 | 81.54 | 67.49 | 16.95 | 49.24 | 154.89 | 72.96 |
| 4% dip | 31.21 | 54.18 | 73.60 | 65.22 | 20.38 | 46.50 | 148.99 | 71.30 |
| 4% dip | 29.72 | 52.32 | 76.04 | 62.90 | 20.22 | 46.64 | 156.93 | 74.15 |
| 6% dip | 30.13 | 53.18 | 76.50 | 62.57 | 17.66 | 45.36 | 150.55 | 72.49 |
| 6% dip | 30.93 | 52.98 | 71.29 | 62.59 | 18.14 | 45.14 | 145.94 | 72.12 |
| 6% dip | 32.10 | 54.72 | 70.47 | 65.23 | 19.21 | 50.72 | 158.01 | 77.76 |

The cook yield (Table 18) for the dipped pickles was lower (ρ<0.05) than the untreated pickles, but this was likely because 94-98% of the dip coating absorbed by the pickles was water, so it evaporated during frying. There were no significant differences (ρ=0.7357) in the yield to green values for any of the treatments. The coated pickles had a crisper texture, less greasy residue during chewing, and less oil remaining on one's fingers after touching the product. Furthermore, the size of the oil residue spots on the untreated pickles' area of the blotting paper was considerably larger (FIGS. 6-7) than that of the coated pickles.

TABLE 18
Yield data mean values (n = 2) for
fried pickles coated in panko bread crumbs.

| | Yield to | Cook |
|---|---|---|
| Sample description | Green (%) | Yield (%) |
| Control | 149.55 | 83.58 ^{b} |
| 2% Proteus V Dry | 155.35 | 72.33 ^{a} |
| 4% Proteus V Dry | 157.64 | 74.28 ^{a} |
| 6% Proteus V Dry | 169.49 | 75.52 ^{a} |

Within each column, means with different letters are significantly different (p < 0.05).

The fat content was also measured quantitatively (FIGS. 8-9) and revealed 27-34% less fat (ρ<0.05) in the dipped pickles than the untreated pickles, but there was no difference (ρ=0.4952) in the percentage of fat reduction between the Proteus V Dry treatments. The treated pickles also had 28-43% higher (ρ<0.05) moisture than the untreated pickles (FIGS. 10-11), but there was no difference (ρ=0.3665) in the percentage of moisture content increase between the Proteus V Dry treatments.

TABLE 19
Metrics from the first replicate of the gourmet breadcrumb dose response study.
Green Wt. was the weight of the pickles. Breaded Wt. was recorded after the
pickles were coated in pre-dust, batter, and breading. Coated Wt.
was recorded after the plant protein solution dip. Fried weight
was recorded after the breaded pickles were removed from the frying oil.

| | | | | | | | Yield | |
|---|---|---|---|---|---|---|---|---|
| | | | Breading | | Coating | | to | Cook |
| | Green | Breaded | Pickup | Coated | Pickup | Fried | Green | Yield |
| Treatment | Wt. (g) | Wt. (g) | (%) | Wt. (g) | %) | Wt. (g) | (%) | (%) |
| Untreated | 31.88 | 55.64 | 74.53 | | | 48.74 | 152.89 | 87.60 |
| Untreated | 31.83 | 54.11 | 70.00 | | | 45.80 | 143.89 | 84.64 |
| Untreated | 30.03 | 51.13 | 70.26 | | | 46.73 | 155.61 | 91.39 |
| 2% dip | 30.39 | 52.01 | 71.14 | 60.35 | 16.04 | 51.12 | 168.21 | 84.71 |
| 2% dip | 30.22 | 51.33 | 69.85 | 59.31 | 15.55 | 50.54 | 167.24 | 85.21 |
| 2% dip | 32.39 | 50.45 | 55.76 | 56.71 | 12.41 | 46.56 | 143.75 | 82.10 |
| 4% dip | 30.88 | 53.66 | 73.77 | 62.85 | 17.13 | 53.77 | 174.13 | 85.55 |
| 4% dip | 29.95 | 49.17 | 64.17 | 56.89 | 15.70 | 48.26 | 161.14 | 84.83 |
| 4% dip | 31.45 | 49.52 | 57.46 | 56.69 | 14.48 | 48.58 | 154.47 | 85.69 |
| 6% dip | 33.13 | 55.09 | 66.28 | 63.92 | 16.03 | 54.62 | 164.87 | 85.45 |
| 6% dip | 33.78 | 52.38 | 55.06 | 59.42 | 13.44 | 52.49 | 155.39 | 88.34 |
| 6% dip | 34.13 | 53.05 | 55.44 | 60.22 | 13.52 | 52.91 | 155.02 | 87.86 |

TABLE 20
Metrics from the second replicate of the gourmet breadcrumb dose response study.
Green Wt. was the weight of the pickles. Breaded Wt. was recorded after the
pickles were coated in pre-dust, batter, and breading. Coated Wt.
was recorded after the plant protein solution dip. Fried weight
was recorded after the breaded pickles were removed from the frying oil.

| | | | | | | | Yield | |
|---|---|---|---|---|---|---|---|---|
| | | | Breading | | Coating | | to | Cook |
| | Green | Breaded | Pickup | Coated | Pickup | Fried | Green | Yield |
| Treatment | Wt. (g) | Wt. (g) | (%) | Wt. (g) | %) | Wt. (g) | (%) | (%) |
| Untreated | 31.63 | 54.15 | 71.20 | | | 47.79 | 151.09 | 88.25 |
| Untreated | 30.15 | 54.61 | 81.13 | | | 48.24 | 160.00 | 88.34 |
| Untreated | 32.61 | 58.87 | 80.53 | | | 51.14 | 156.82 | 86.87 |
| 2% dip | 30.51 | 56.86 | 86.37 | 64.75 | 13.88 | 56.68 | 185.78 | 87.54 |
| 2% dip | 32.90 | 54.65 | 66.11 | 61.06 | 11.73 | 53.59 | 162.89 | 87.77 |
| 2% dip | 32.56 | 56.85 | 74.60 | 64.60 | 13.63 | 56.24 | 172.73 | 87.06 |
| 4% dip | 32.78 | 58.92 | 79.74 | 67.69 | 14.88 | 57.18 | 174.44 | 84.47 |
| 4% dip | 32.11 | 54.45 | 69.57 | 62.16 | 14.16 | 53.37 | 166.21 | 85.86 |
| 4% dip | 31.29 | 51.90 | 65.87 | 58.64 | 12.99 | 48.87 | 156.18 | 83.34 |
| 6% dip | 33.34 | 58.25 | 74.72 | 66.88 | 14.82 | 55.56 | 166.65 | 83.07 |
| 6% dip | 31.53 | 56.65 | 79.67 | 65.21 | 15.11 | 56.31 | 178.59 | 86.35 |
| 6% dip | 32.32 | 59.24 | 83.29 | 68.72 | 16.00 | 59.45 | 183.94 | 86.51 |

For the gourmet bread crumbs, there were no significant differences between any of the treatments for cook yield (ρ=0.3464) or yield to green (ρ=0.4067) (Table 21). The coated pickles were crispier and less greasy than the untreated pickles. Furthermore, the size of the oil residue spots on the untreated pickles' area of the blotting paper was considerably larger (FIGS. 12-13) than that of the coated pickles.

TABLE 21
Yield data mean values (n = 2) for
fried pickles coated in gourmet bread crumbs.

| | Yield to | Cook |
|---|---|---|
| Sample description | Green (%) | Yield (%) |
| Control | 153.38 | 87.85 |
| 2% Proteus V Dry | 166.77 | 85.73 |
| 4% Proteus V Dry | 164.43 | 84.96 |
| 6% Proteus V Dry | 167.41 | 86.26 |

The fat content was also measured quantitatively (FIGS. 14-15) and revealed 19-32% less fat (ρ<0.05) in the dipped pickles than the untreated pickles. The 6% Proteus V Dry achieved a higher (ρ<0.05) percentage of fat reduction than the 2% Proteus V Dry, but neither were different than the 4% Proteus V Dry treatment. There was no difference (ρ=0.2190) between the moisture content (FIGS. 16-17) of the untreated or treated pickles, so naturally there were also no differences (ρ=0.6478) in the percentage of moisture content increase between the Proteus V Dry treatments.

TABLE 22
Metrics from the first replicate of the plain breadcrumb dose response study.
Green Wt. was the weight of the pickles. Breaded Wt. was recorded after the
pickles were coated in pre-dust, batter, and breading. Coated Wt.
was recorded after the plant protein solution dip. Fried weight
was recorded after the breaded pickles were removed from the frying oil.

| | | | | | | | Yield | |
|---|---|---|---|---|---|---|---|---|
| | | | Breading | | Coating | | to | Cook |
| | Green | Breaded | Pickup | Coated | Pickup | Fried | Green | Yield |
| Treatment | Wt. (g) | Wt. (g) | (%) | Wt. (g) | %) | Wt. (g) | (%) | (%) |
| Untreated | 30.27 | 47.92 | 58 31 | | | 42.09 | 139.05 | 87.83 |
| Untreated | 31.64 | 52.67 | 66 47 | | | 47.21 | 149.21 | 89.63 |
| Untreated | 30.96 | 53.85 | 73.93 | | | 47.08 | 152.07 | 87.43 |
| 2% dip | 30.96 | 48.13 | 55.46 | 54.45 | 13.13 | 47.45 | 153.26 | 87.14 |
| 2% dip | 31.18 | 50.44 | 61.77 | 57.35 | 13.70 | 49.49 | 158.72 | 86.29 |
| 2% dip | 30.26 | 47.75 | 57.80 | 52.96 | 10.91 | 46.51 | 153.70 | 87.82 |
| 4% dip | 31.17 | 50.99 | 63.59 | 57.88 | 13.51 | 50.51 | 162.05 | 87.27 |
| 4% dip | 30.09 | 49.42 | 64.24 | 56.12 | 13.56 | 48.29 | 160.49 | 86.05 |
| 4% dip | 31.06 | 50.86 | 63.75 | 57.03 | 12.13 | 49.56 | 159.56 | 86.90 |
| 6% dip | 32.36 | 55.78 | 72.37 | 63.09 | 13.11 | 53.85 | 166.41 | 85.35 |
| 6% dip | 32.22 | 57.98 | 79.95 | 66.17 | 14.13 | 59.31 | 184.08 | 89.63 |
| 6% dip | 31.87 | 53.59 | 68.15 | 60.36 | 12.63 | 52.90 | 165.99 | 87.64 |

TABLE 23
Metrics from the second replicate of the plain breadcrumb dose response study.
Green Wt. was the weight of the pickles. Breaded Wt. was recorded after the pickles
were coated in pre-dust, batter, and breading. Coated Wt. was recorded after the plant
protein solution dip. Fried weight was recorded after the breaded
pickles were removed from the frying oil.

| | | | | | | | Yield | |
|---|---|---|---|---|---|---|---|---|
| | | | Breading | | Coating | | to | Cook |
| | Green | Breaded | Pickup | Coated | Pickup | Fried | Green | Yield |
| Treatment | Wt. (g) | Wt. (g) | (%) | Wt. (g) | %) | Wt. (g) | (%) | (%) |
| Untreated | 31.29 | 52.57 | 68.01 | | | 46.53 | 148.71 | 88.51 |
| Untreated | 31.80 | 51.05 | 60.53 | | | 46.23 | 145.38 | 90.56 |
| Untreated | 31.40 | 54.65 | 74.04 | | | 49.69 | 158.25 | 90.92 |
| 2% dip | 31.50 | 52.92 | 68.00 | 59.98 | 13.34 | 51.77 | 164.35 | 86.31 |
| 2% dip | 32.43 | 53.40 | 64.66 | 60.32 | 12.96 | 54.30 | 167.44 | 90.02 |
| 2% dip | 30.85 | 50.60 | 64.02 | 57.53 | 13.70 | 49.33 | 159.90 | 85.75 |
| 4% dip | 30.79 | 54.96 | 78.50 | 62.72 | 14.12 | 52.85 | 171.65 | 84.26 |
| 4% dip | 31.03 | 53.20 | 71.45 | 60.59 | 13.89 | 51.77 | 166.84 | 85.44 |
| 4% dip | 32.57 | 53.19 | 63.31 | 60.40 | 13.56 | 52.15 | 160.12 | 86.34 |
| 6% dip | 32.28 | 52.62 | 63.01 | 60.80 | 15.55 | 50.27 | 155.73 | 82.68 |
| 6% dip | 32.06 | 51.06 | 59.26 | 58.59 | 14.75 | 51.94 | 162.01 | 88.65 |
| 6% dip | 31.94 | 55.68 | 74.33 | 64.25 | 15.39 | 53.81 | 168.47 | 83.75 |

For the plain bread crumbs, there were no significant differences between any of the treatments for cook yield (ρ=0.1692), but there was a trend (ρ=0.0902) towards statistical significance for the yield to green results showing higher yield for the 4% and 6% Proteus V Dry treatments compared to the untreated control (Table 24). The coated pickles had a crisper texture, less greasy residue during chewing, and less oil remaining on one's fingers after touching the product. Furthermore, the size of oil the residue spots remaining on the untreated pickles' area of the blotting paper was considerably larger than that of the coated pickles (FIGS. 18-19).

TABLE 24
Yield data mean values (n = 2) for
fried pickles coated in plain bread crumbs.

| | Yield to | Cook |
|---|---|---|
| Sample description | Green (%) | Yield (%) |
| Control | 148.78^{a} | 89.15 |
| 2% Proteus V Dry | 159.56^{ab} | 87.22 |
| 4% Proteus V Dry | 163.45^{b} | 86.04 |
| 6% Proteus V Dry | 167.11^{b} | 86.28 |

Within each column, means with different letters are significantly different (p < 0.10).

The fat content was also measured quantitatively (FIGS. 20-21) and revealed the nearly significant trend of 22-27% less fat (ρ=0.0801) in the dipped pickles than the untreated pickles, but there was no difference (ρ=0.9344) in the percentage of fat reduction between the Proteus V Dry treatments. The treated pickles also had 20-26% higher (ρ<0.05) moisture than the untreated pickles (FIGS. 22-23), but there was no difference (ρ=0.8443) in the percentage of moisture content increase between the Proteus V Dry treatments. For each bread crumb type, the microbarrier-coated fried pickles left less greasy residue on the blotting paper and had a crisper texture and less greasy mouthfeel. Furthermore, the coated pickle chips had lower fat and higher moisture than the uncoated breaded pickles. The fat-blocking ability was consistent across all application rates, with the ideal application rate between about 0.2 to about 0.7% of Proteus V Dry delivered to the breaded product. The versatility of this product to work well across all three types of bread crumbs was surprising and shows many advantages including ease of use and potential efficiency, as food processors will reduce use of frying oil and its associated expense due to the reduced oil uptake. Since the price of frying oil has outpaced the inflation rate of food prices, reducing oil use during frying is a welcome benefit to food processors who continue to face supply chain and pricing pressures.

### Example 5

### Materials and Methods:

The ingredients and raw materials used in this study are listed in Table 25. A target customer identified three commonly used bread crumb types among those available from the foodservice supply vendor webstaurantstore.com. Our intention was that these three types of breadcrumbs would closely resemble the proprietary breadcrumbs used by target customers. The customer chose Japanese style panko breadcrumbs (crustless yeast leavened wheat bread), plain breadcrumbs (yeast leavened wheat bread), and gourmet breadcrumbs (chemically leavened, extruded). Each breading type was conducted as a separate experiment, and each was replicated twice. Fresh frying oil, batter, and dipping solutions were prepared for the 15 frying batches conducted for each breading type. Batter (300 g) was made by combining 30% batter mix and 70% cold spring water in a mixing bowl. The mixture was blended until homogenous using a handheld immersion blender (Kitchen Aid). Pre-dust was prepared by grinding the respective type of breading in a food processor (Cuisinart) for 30 seconds until it resembled a fine powder. Pre-frying dipping treatments (200 g, Table 26) were prepared to evaluate the fat-blocking ability of various levels of Proteus® V Dry (0, 2%, 4%, and 6%), which is a combination of pea protein and lentil protein acidified to pH 4.50. Proteus V Dry and water were blended until homogenous using an immersion blender.

TABLE 25
Ingredients used in this study.

| Material | Item # | Lot # | Supplier |
|---|---|---|---|
| Proteus | 018246 | 20220201 | Kemin Food |
| V Dry | | | Technologies |
| | | | sampling |
| Spring | N/A | N/A | Crystal Clear |
| water | | | (Des Moines, IA) |
| Canola oil | N/A | 122721- | Fareway |
| replicate 1 | | 8336 | (Ankeny, IA) |
| Canola oil | N/A | 011422- | Fareway |
| replicate 2 | | 9468 | (Ankeny, IA) |
| Golden Dipt | 103GD700121 | N/A | Kerry Ingredients via |
| pre-dip | | | webstaurantstore.com |
| batter mix | | | |
| Golden Dipt | 104GD0048707 | N/A | Kerry Ingredients via |
| plain | | | webstaurantstore.com |
| breadcrumbs | | | |
| Golden Dipt | 104GD4301707 | N/A | Kerry Ingredients via |
| gourmet | | | webstaurantstore.com |
| breadcrumbs | | | |
| Panko Japanese | 13705010 | N/A | Kikkoman USA via |
| style toasted | | | webstaurantstore.com |
| breadcrumbs | | | |
| Just Bare | N/A | N/A | Hy Vee |
| chicken | | | (Ankeny, IA) |
| tenders | | | |
| replicate 1 | | | |
| HyVee brand | N/A | N/A | Hy Vee |
| chicken | | | (Ankeny, IA) |
| tenders | | | |
| replicate 2 | | | |

TABLE 26
Dipping treatments for each breading type
Description

Untreated control - no dip. Three batches for
break-in, three batches for experiment.
2% Proteus V Dry - three batches
4% Proteus V Dry - three batches
6% Proteus V Dry - three batches

Canola oil (2500 g) was poured into a 9-cup, 1800 W digital deep fryer (Presto ProFry #05462). The thermostat was set to preheat to 375° F. (190.5° C.). The packaged chicken tenderloins were each cut into four portions, and the pieces were sorted into groups of four that weighed 50-60 g. This batch weight target represented the optimum ratio of deep-fried food:oil (1:20-1:40) necessary to prevent an excessive reduction in oil temperature upon addition of the food. The weight of the uncoated chicken was recorded as the green weight. Three batches of chicken were stored at room temperature while they were battered, breaded, and fried, and the remaining batches were covered with plastic cling wrap and refrigerated until it was time to coat and fry them. For the first step of the coating process, the chicken for each batch was placed into the bowl of pre-dust and tossed. The pieces were removed from the pre-dust and lightly shaken to remove the excess. The dusted chicken was then dipped into the bowl of batter and fully submerged. Next, the battered product was placed into a bowl of breadcrumbs and tossed vigorously to assure full coverage. The chicken was gently shaken to remove excess bread crumb. Six batches of breaded chicken were not dipped in the protein bath before frying, but the remaining nine batches were dipped in the respective protein solutions immediately before frying. The chicken was lowered into the bowl of protein dip solution for 1 second using a slotted spoon, and then they were weighed to record the dipped weight.

Three batches of breaded but undipped chicken were fried to condition the oil and confirm the frying time. These batches were discarded after frying. The chicken was added to the fryer basket which was lowered into the oil and fried for 1.5 minutes until golden brown. The fryer basket was raised from the oil, the tenders were drained for about 10 seconds, and then they were weighed to record the fried weight. One chicken tender from each batch was immediately placed into a sterile polyethylene bag with a fold-down wire closure (Fisher Scientific #14-955-176). The bag was closed and placed on an aluminum baking sheet in the freezer. The remaining tenders were spread out on brown blotting paper (Uline 24″ kraft paper #S3575) where they remained until they were cool to the touch.

Yield calculations. The breading pickup percentage was calculated using Equation 14. The Proteus V Dry coating uptake percentage was calculated using Equation 15. Equation 16 was used to calculate the actual quantity of Proteus V Dry delivered to each batch of chicken. The yield to green weight percentage was calculated using Equation 17. Cook yield percentage for the untreated chicken was calculated using Equation 18, and the cook yield percentage for the protein-coated chicken was calculated using Equation 19. For each breading type, two replications were performed, five weeks apart.

$$Breading pickup calculation .$$

$$( \frac{breaded weight - green weight}{green weight} ) \times 100 = breading pickup ( \% ) \qquad Equation 14$$

$$Proteus V Dry coating pickup calculation .$$

$$( \frac{coated weight - breaded weight}{breaded weight} ) \times 100 = coating pickup ( \% ) \qquad Equation 15$$

$$Actual Proteus V Dry ( \% ) delivered to the chicken .$$

$$Proteus V Dry coating pickup ( \% ) \times Proteus V Dry concentration ( \% ) in dipping solution = Proteus V Dry ( \% ) delivered to chicken \qquad Equation 16$$

$$Yield to green weight calculation .$$

$$( \frac{fried weight}{breaded weight} ) \times 100 = cook yield ( \% ) \qquad Equation 17$$

$$Cook yield calculation for the untreated chicken .$$

$$( \frac{fried weight}{breaded weight} ) \times 100 = cook yield ( \% ) \qquad Equation 18$$

$$Cook yield calculation for the protein - dipped chicken .$$

$$( \frac{fried weight}{coated weight} ) \times 100 = cook yield ( \% ) \qquad Equation 19$$

Nutritional analysis. The frozen chicken tenders from each treatment batch were partially thawed, cut into cubes with a knife, and ground in a coffee grinder until homogenous. The moisture content of each sample was analyzed using the CEM Smart 6 Microwave+Infrared Moisture and Solids Analyzer, and then the sample was transferred to the Oracle Rapid NMR Fat Analyzer (CEM Corporation, Matthews, N.C.) to measure the fat content.

Statistical analysis. Within each breading type, fat, moisture, and cook yield values were subjected to one-way analysis of variance (ANOVA) based on treatment using the STATGRAPHICS® Centurion 18 software package. When the ANOVA was significant (ρ<0.05), differences between the treatments were assessed using Fisher's least significant differences.

Results and analysis. The results are summarized in Tables 27-35.

TABLE 27
Metrics from the first replicate of the panko breadcrumb dose response study.
Green Wt. was the weight of the chicken. Breaded Wt. was recorded after the chicken
were coated in pre-dust, batter, and breading. Coated Wt. was recorded after the plant
protein solution dip. Fried weight was recorded after the
breaded chicken were removed from the frying oil.

| | | | | | | | Yield | |
|---|---|---|---|---|---|---|---|---|
| | | | Breading | | Coating | | to | Cook |
| | Green | Breaded | Pickup | Coated | Pickup | Fried | Green | Yield |
| Treatment | Wt. (g) | Wt. (g) | (%) | Wt. (g) | %) | Wt. (g) | (%) | (%) |
| Untreated | 58.46 | 79.98 | 36.81 | | | 73.94 | 126.48 | 92.45 |
| Untreated | 59.11 | 78.83 | 33.36 | | | 70.68 | 119.57 | 89.66 |
| Untreated | 60.72 | 83.09 | 36.84 | | | 75.28 | 123.98 | 90.60 |
| 2% dip | 67.64 | 90.20 | 33.35 | 100.69 | 11.63 | 84.89 | 125.50 | 84.31 |
| 2% dip | 65.94 | 85.88 | 30.24 | 94.90 | 10.50 | 80.06 | 121.41 | 84.36 |
| 2% dip | 68.12 | 93.45 | 37.18 | 104.37 | 11.69 | 86.59 | 127.11 | 82.96 |
| 4% dip | 70.08 | 93.26 | 33.08 | 105.20 | 12.80 | 90.74 | 129.48 | 86.25 |
| 4% dip | 72.91 | 99.84 | 36.94 | 112.53 | 12.71 | 98.40 | 134.96 | 87.44 |
| 4% dip | 75.11 | 102.52 | 36.49 | 114.08 | 11.28 | 99.63 | 132.65 | 87.33 |
| 6% dip | 66.76 | 95.45 | 42.97 | 108.49 | 13.66 | 92.64 | 138.77 | 85.39 |
| 6% dip | 63.20 | 92.66 | 46.61 | 104.28 | 12.54 | 91.36 | 144.56 | 87.61 |
| 6% dip | 70.36 | 102.70 | 45.96 | 115.41 | 12.38 | 100.66 | 143.06 | 87.22 |

TABLE 28
Metrics from the second replicate of the panko breadcrumb dose response study.
Green Wt. was the weight of the chicken. Breaded Wt. was recorded after the chicken
were coated in pre-dust, batter, and breading. Coated Wt. was recorded after the plant
protein solution dip. Fried weight was recorded after the
breaded chicken were removed from the frying oil.

| | | | | | | | Yield | |
|---|---|---|---|---|---|---|---|---|
| | | | Breading | | Coating | | to | Cook |
| | Green | Breaded | Pickup | Coated | Pickup | Fried | Green | Yield |
| Treatment | Wt. (g) | Wt. (g) | (%) | Wt. (g) | %) | Wt. (g) | (%) | (%) |
| Untreated | 58.66 | 81.7 | 39.28 | | | 75.1 | 128.03 | 91.92 |
| Untreated | 59.28 | 80.85 | 36 39 | | | 74.58 | 125.81 | 92.24 |
| Untreated | 57.86 | 78.45 | 35.59 | | | 71.81 | 124.11 | 91.54 |
| 2% dip | 61.05 | 83.98 | 37.56 | 96.50 | 14.91 | 81.95 | 134.23 | 84.92 |
| 2% dip | 61.64 | 84.30 | 36.76 | 96.87 | 14.91 | 78.31 | 127.04 | 80.84 |
| 2% dip | 61.06 | 91.60 | 50.02 | 104.93 | 14.55 | 88.05 | 144.20 | 83.91 |
| 4% dip | 62.09 | 84.59 | 36.24 | 96.36 | 13.91 | 80.52 | 129.68 | 83.56 |
| 4% dip | 58.62 | 82.09 | 40.04 | 94.62 | 15.26 | 80.58 | 137.46 | 85.16 |
| 4% dip | 59.37 | 83.63 | 40.86 | 95.71 | 14.44 | 81.93 | 138.00 | 85.60 |
| 6% dip | 58.58 | 79.87 | 36.34 | 91.80 | 14.94 | 78.71 | 134.36 | 85.74 |
| 6% dip | 63.70 | 89.77 | 40.93 | 103.11 | 14.86 | 87.25 | 136.97 | 84.62 |
| 6% dip | 60.80 | 85.18 | 40.10 | 99.80 | 17.16 | 85.24 | 140.20 | 85.41 |

The cook yield (Table 29) for the dipped chicken was lower (ρ<0.05) than the untreated chicken, but this was likely because 96% of the dip coating absorbed by the chicken was water, so it evaporated during frying. For the yield to green values, the treatments were numerically higher than the control, amounting to trends that approached conventional levels of significance (ρ=0.0964). The coated chicken had a crisper texture, less greasy residue during chewing, and less oil remaining on one's fingers after touching the product. Furthermore, the size of the oil residue spots on the untreated chicken area of the blotting paper was noticeably larger (FIGS. 24-25) than that of the coated chicken. The Proteus V treatment had an inconsistent and minimal impact on the breading adhesion (FIG. 26). For some of the batches within some of the treatment levels, there was a visible space between the breading layer and the chicken after it was cross sectionally sliced with a kitchen knife, but the breading shell did not fall off during handling.

TABLE 29
Yield data mean values (n = 2) for
fried chicken coated in panko breadcrumbs.

| Sample | Yield to | Cook |
|---|---|---|
| description | Green (%) | Yield (%) |
| Control | 124.66^{x} | 91.40^{b} |
| 2% Proteus V Dry | 129.92^{xy} | 83.56^{a} |
| 4% Proteus V Dry | 133.71^{xy} | 85.90^{a} |
| 6% Proteus V Dry | 139.66^{y} | 86.00^{a} |

^{x, y}Within each column, means with different letters are significantly different (p < 0.10).
^{a, b}Within each column, means with different letters are significantly different (p < 0.05).

The fat content was also measured quantitatively (FIGS. 27-28) and revealed 22-34% less fat (ρ=0.0609) in the dipped chicken than the untreated chicken, but there was no difference (ρ=0.5715) in the percentage of fat reduction across the Proteus V Dry treatments. The treated chicken also had 9-15% numerically higher (ρ=0.1993) moisture than the untreated chicken (FIGS. 29-30), but there was no difference (ρ=0.6732) in the percentage of moisture content increase between the Proteus V Dry treatments.

TABLE 30
Metrics from the first replicate of the gourmet breadcrumb dose response study.
Green Wt. was the weight of the chicken. Breaded Wt. was recorded after the chicken
were coated in pre-dust, batter, and breading. Coated Wt. was recorded after the plant
protein solution dip. Fried weight was recorded after the
breaded chicken were removed from the frying oil.

| | | | | | | | Yield | |
|---|---|---|---|---|---|---|---|---|
| | | | Breading | | Coating | | to | Cook |
| | Green | Breaded | Pickup | Coated | Pickup | Fried | Green | Yield |
| Treatment | Wt. (g) | Wt. (g) | (%) | Wt. (g) | %) | Wt. (g) | (%) | (%) |
| Untreated | 71.12 | 94.09 | 32.30 | | | 86.69 | 121.89 | 92.14 |
| Untreated | 68.57 | 89.75 | 30.89 | | | 85.99 | 125.40 | 95.81 |
| Untreated | 62.07 | 82.58 | 33.04 | | | 79.00 | 127.28 | 95.66 |
| 2% dip | 67.69 | 96.06 | 41.91 | 105.29 | 9.61 | 97.94 | 144.69 | 93.02 |
| 2% dip | 70.00 | 96.54 | 37.91 | 104.27 | 8.01 | 91.74 | 131.06 | 87.98 |
| 2% dip | 66.89 | 94.59 | 41.41 | 103.13 | 9.03 | 95.87 | 143.32 | 92.96 |
| 4% dip | 66.90 | 92.83 | 38.76 | 103.00 | 10.96 | 94.87 | 141.81 | 92.11 |
| 4% dip | 74.95 | 104.08 | 38.87 | 113.44 | 8.99 | 106.01 | 141.44 | 93.45 |
| 4% dip | 60.34 | 87.42 | 44.88 | 95.40 | 9.13 | 87.38 | 144.81 | 91.59 |
| 6% dip | 70.88 | 96.11 | 35.60 | 106.19 | 10.49 | 99.56 | 140.46 | 93.76 |
| 6% dip | 69.89 | 97.22 | 39.10 | 106.93 | 9.99 | 98.81 | 141.38 | 92.41 |
| 6% dip | 64.09 | 92.53 | 44.38 | 102.79 | 11.09 | 95.57 | 149.12 | 92.98 |

TABLE 31
Metrics from the second replicate of the gourmet breadcrumb dose response study.
Green Wt. was the weight of the chicken. Breaded Wt. was recorded after the chicken
were coated in pre-dust, batter, and breading. Coated Wt. was recorded after the plant
protein solution dip. Fried weight was recorded after the
breaded chicken were removed from the frying oil.

| | | | | | | | Yield | |
|---|---|---|---|---|---|---|---|---|
| | | | Breading | | Coating | | to | Cook |
| | Green | Breaded | Pickup | Coated | Pickup | Fried | Green | Yield |
| Treatment | Wt. (g) | Wt. (g) | (%) | Wt. (g) | %) | Wt. (g) | (%) | (%) |
| Untreated | 67.51 | 89.35 | 32.35 | | | 83.40 | 123.54 | 93.34 |
| Untreated | 63.23 | 83.90 | 32.69 | | | 79.27 | 125.37 | 94.48 |
| Untreated | 65.02 | 87.73 | 34.93 | | | 83.44 | 128.33 | 95.11 |
| 2% dip | 61.94 | 83.44 | 34.71 | 91.63 | 9.82 | 84.11 | 135.79 | 91.79 |
| 2% dip | 63.54 | 85.07 | 33.88 | 92.60 | 8.85 | 85.83 | 135.08 | 92.69 |
| 2% dip | 65.73 | 88.64 | 34.85 | 96.36 | 8.71 | 89.01 | 135.42 | 92.37 |
| 4% dip | 63.43 | 86.61 | 36.54 | 95.85 | 10.67 | 87.75 | 138.34 | 91.55 |
| 4% dip | 64.89 | 85.62 | 31.95 | 94.06 | 9.86 | 87.98 | 135.58 | 93.54 |
| 4% dip | 71.12 | 97.54 | 37.15 | 106.75 | 9.44 | 99.87 | 140.42 | 93.56 |
| 6% dip | 67.13 | 90.78 | 35.23 | 99.62 | 9.74 | 91.22 | 135.89 | 91.57 |
| 6% dip | 60.79 | 82.00 | 34.89 | 90.45 | 10.30 | 82.83 | 136.26 | 91.58 |
| 6% dip | 62.90 | 85.53 | 35.98 | 94.37 | 10.34 | 87.95 | 139.83 | 93.20 |

The cook yield (Table 32) for the dipped chicken was lower (ρ<0.05) than the untreated chicken, but this was likely because 96% of the dip coating absorbed by the chicken was water, so it evaporated during frying. For the yield to green values, the treatments were higher (ρ<0.05) than the control, but there were no differences between the treatments.

The coated chicken was crispier and less greasy than the untreated chicken. Furthermore, the oil residue spots on the untreated chicken area of the blotting paper were larger (FIG. 31-32) than that of the coated chicken. The Proteus V treatment had minimal impact on the breading adhesion (FIG. 33). For some of the batches within some of the treatment levels, there was a visible space between the breading layer and the chicken after it was cross sectionally sliced with a kitchen knife, but the breading shell did not fall off during handling.

TABLE 32
Yield data mean values (n = 2) for
fried chicken coated in gourmet breadcrumbs.

| | Yield to | Cook |
|---|---|---|
| Sample description | Green (%) | Yield (%) |
| Control | 125.30^{a} | 94.43^{a} |
| 2% Proteus V Dry | 137.56^{b} | 91.80^{b} |
| 4% Proteus V Dry | 140.41^{b} | 92.63^{b} |
| 6% Proteus V Dry | 140.49^{b} | 92.58^{b} |

^{a, b}Within each column, means with different letters are significantly different (p < 0.05).

The fat content was also measured quantitatively (FIGS. 34-35) and revealed 24-40% less fat (ρ<0.05) in the dipped chicken than the untreated chicken, but there was no difference (ρ=0.3066) in the percentage of fat reduction across the Proteus V Dry treatments. There was no difference (ρ=0.4441) between the moisture content (FIGS. 36-37) of the untreated or treated chicken, so consequently, there were also no differences (ρ=0.4094) in the percentage of moisture content increase between the Proteus V Dry treatments.

TABLE 33
Metrics from the first replicate of the plain breadcrumb dose response study. Green
Wt. was the weight of the chicken. Breaded Wt. was recorded after the chicken
were coated in pre-dust, batter, and breading. Coated Wt. was recorded after the plant
protein solution dip. Fried weight was recorded after the
breaded chicken were removed from the frying oil.

| | | | | | | | Yield | |
|---|---|---|---|---|---|---|---|---|
| | | | Breading | | Coating | | to | Cook |
| | Green | Breaded | Pickup | Coated | Pickup | Fried | Green | Yield |
| Treatment | Wt. (g) | Wt. (g) | (%) | Wt. (g) | %) | Wt. (g) | (%) | (%) |
| Untreated | 71.98 | 94.01 | 30.61 | | | 88.18 | 122.51 | 93.80 |
| Untreated | 59.37 | 77.47 | 30.49 | | | 72.70 | 122.45 | 93.84 |
| Untreated | 70.62 | 96.40 | 36.51 | | | 91.67 | 129.81 | 95.09 |
| 2% dip | 68.78 | 93.59 | 36.07 | 100.83 | 7.74 | 94.33 | 137.15 | 93.55 |
| 2% dip | 55.20 | 74.05 | 34.15 | 80.01 | 8.05 | 74.29 | 134.58 | 92.85 |
| 2% dip | 62.83 | 83.48 | 32.87 | 90.13 | 7.97 | 83.78 | 133.34 | 92.95 |
| 4% dip | 59.37 | 78.98 | 33.03 | 84.11 | 6.50 | 78.08 | 131.51 | 92.83 |
| 4% dip | 57.93 | 80.07 | 38.22 | 85.39 | 6.64 | 79.04 | 136.44 | 92.56 |
| 4% dip | 58.26 | 80.35 | 37.92 | 86.04 | 7.08 | 78.63 | 134.96 | 91.39 |
| 6% dip | 58.48 | 80.93 | 38.39 | 88.07 | 8.82 | 81.66 | 139.64 | 92.72 |
| 6% dip | 63.81 | 86.90 | 36.19 | 93.96 | 8.12 | 89.68 | 140.54 | 95.44 |
| 6% dip | 68.19 | 92.25 | 35.28 | 99.77 | 8.15 | 93.28 | 136.79 | 93.50 |

TABLE 34
Metrics from the second replicate of the plain breadcrumb dose response study. Green
Wt. was the weight of the chicken. Breaded Wt. was recorded after the chicken
were coated in pre-dust, batter, and breading. Coated Wt. was recorded after the plant
protein solution dip. Fried weight was recorded after the
breaded chicken were removed from the frying oil.

| | | | | | | | Yield | |
|---|---|---|---|---|---|---|---|---|
| | | | Breading | | Coating | | to | Cook |
| | Green | Breaded | Pickup | Coated | Pickup | Fried | Green | Yield |
| Treatment | Wt. (g) | Wt. (g) | (%) | Wt. (g) | %) | Wt. (g) | (%) | (%) |
| Untreated | 61.46 | 80.75 | 31.39 | | | 76.57 | 124.59 | 94.2 |
| Untreated | 60.84 | 78.04 | 28.27 | | | 72.69 | 119.48 | 93.4 |
| Untreated | 62.96 | 83.27 | 32.26 | | | 78.36 | 124.46 | 94.0 |
| 2% dip | 62.51 | 83.28 | 33.23 | 88.63 | 6.42 | 82.38 | 131.79 | 92.5 |
| 2% dip | 60.36 | 79.46 | 31.64 | 84.94 | 6.90 | 77.78 | 128.86 | 91.7 |
| 2% dip | 59.97 | 81.88 | 36.53 | 87.23 | 6.53 | 80.70 | 134.57 | 92.1 |
| 4% dip | 61.57 | 81.83 | 32.91 | 88.58 | 8.25 | 80.57 | 130.86 | 90.6 |
| 4% dip | 59.80 | 80.17 | 34.06 | 86.27 | 7.61 | 80.80 | 135.12 | 93.6 |
| 4% dip | 60.05 | 80.77 | 34.50 | 86.80 | 7.47 | 80.91 | 134.74 | 93.1 |
| 6% dip | 61.07 | 83.74 | 37.12 | 90.79 | 8.42 | 83.12 | 136.11 | 91.5 |
| 6% dip | 59.14 | 80.70 | 36.46 | 87.69 | 8.66 | 81.14 | 137.20 | 92.3 |
| 6% dip | 61.54 | 81.46 | 32.37 | 87.31 | 7.18 | 80.74 | 131.20 | 92.8 |

For the plain breadcrumbs, there were no significant differences between any of the treatments for cook yield (ρ=0.2097), but there was statistical significance (ρ<0.05) for the yield to green results showing higher yield for all Proteus V Dry treatments compared to the untreated control (Table 35). The coated chicken had a crisper texture, less greasy residue during chewing, and less oil remaining on one's fingers after touching the product. Furthermore, the size of the oil residue spots remaining on the untreated chicken area of the blotting paper was slightly larger than that of the coated chicken (FIG. 38-39). The Proteus V treatment had an inconsistent and minimal impact on the breading adhesion (FIG. 40). For some of the batches within some of the treatment levels, there was a visible space between the breading layer and the chicken after it was cross sectionally sliced with a kitchen knife, but the breading shell did not fall off during handling.

TABLE 35
Yield data mean values (n = 2) for
fried chicken coated in plain breadcrumbs.

| Sample | Yield to | Cook |
|---|---|---|
| description | Green (%) | Yield (%) |
| Control | 123.88^{a} | 94.13 |
| 2% Proteus V Dry | 133.38^{b} | 92.73 |
| 4% Proteus V Dry | 133.94^{b} | 92.44 |
| 6% Proteus V Dry | 136.92^{b} | 93.04 |

Within each column, means with different letters are significantly different (p < 0.05).

The fat content was also measured quantitatively (FIGS. 41-42) and revealed the nearly significant trend of 29-41% less fat (ρ=0.0608) in the dipped chicken than the untreated chicken, but there was no difference (ρ=0.7409) in the percentage of fat reduction between the Proteus V Dry treatments. The treated chicken also had 8-10% higher (ρ<0.05) moisture than the untreated chicken (FIGS. 43-44), but there was no difference (ρ=0.8566) in the percentage of moisture content increase between the Proteus V Dry treatments.

In all three experiments, the coated chicken tenders had a lower (ρ<0.05) fat content than the uncoated breaded chicken. While they had a numerical increase in moisture content for all three breading types, only the differences for the plain breadcrumbs were significant. The acidified plant protein solution improved the eating experience of the chicken, making them more crunchy and less greasy feeling. The fat-blocking ability was consistent across all three application rates, with the ideal application rate between 0.15-0.85% of Proteus V Dry delivered to the breaded product. The versatility was surprising, where the product performed well across all three types of breading tested. Advantages of the product include ease of use and efficiency, where food processors save money on frying oil due to the reduced oil uptake.

### Example 6

### Materials and Methods:

Chemicals and reagents. Reagents and chemicals that were used in this mozzarella stick study are summarized in Table 36. Proteus®-V powder was blended cold water and the pH of the resultant blend was 4.45.

TABLE 36
Reagents and chemicals that were used in this study.

| | RM # or | | |
|---|---|---|---|
| Material | Item # | Lot # | Supplier |
| Proteus V Dry* | M018246 | 20220404- | Kemin Food |
| | | 01 | Technologies, Inc. |
| | | | (Des Moines IA) |
| Citric acid | RM16450 | N/A | |
| Spring Water | N/A | N/A | Crystal Clear |
| Canola Oil | N/A | 0023260851 | Sam's West, Inc. |
| | | 1237 | (Bentonville, AR) |
| Batter | 103GD700121 | Pre-dip | Kerry Ingredients |
| | | batter mix | (Beloit, WI) |
| Breading | 104GD4301707 | Gourmet | Kerry Ingredients |
| | | Coating | (Beloit, WI) |
| | | Crumbs | |
| String Cheese | N/A | 93968 | Sam's West, Inc. |
| sticks | | 05356 | (Bentonville, AR) |

Mozzarella stick procedure. These procedures were run on two separate days, allowing for true replication (N=2), using fresh oil, batter and breading at the beginning of each day. Raw string cheese sticks were peeled out of their casing and put into groups of six. The researchers selected six sticks as a batch size because that amount fit into the fryer basket without crowding. The cheese sticks were battered and breaded using a two-pass system. The dry batter component was placed into a mixing bowl and the water component was added while hand mixing vigorously with a wire whisk. A Bettcher Automatic Batter and Breading System was utilized to apply the batter and breading. Following the directions of the machine, the breadcrumbs were placed into the unit until a “wave” appeared in the breading. The top unit was filled with hydrated batter until it reached the fill-hole. String cheese sticks were placed one-at-a-time onto the belt facing lengthwise. The unit underwent one batter and breading pass and was captured and re-sent back through the unit for a second pass. Pickups were measured throughout the run to assure consistent pickups.

For control product the battered and breaded sticks were placed directly into the hot frying oil. For the protein-added samples, the battered and breaded cheese sticks were hand dipped for approximately one second in a bowl of hydrated Proteus® V-Dry. Dipped product was subsequently slightly shaken to remove excess protein and placed into the fryer.

Frying Procedure. Frying was accomplished using two separate Presto Digital ProFry units (National Presto Industries, Inc., Eau Claire, Wis.). One for controls and one for Proteus®-V samples. Three quarts (2.84 liters) of fresh oil was placed into the frying unit and heated until 375° F. was achieved. A green light signified that the temperature had returned to 375° F. after each batch. New oil was added at the beginning of each day. Coated cheese sticks were placed into the fry baskets and dropped into the oil for 45 seconds, afterwards being drained for approximately five seconds prior to being weighed. A total of 120 mozzarella sticks were processed each day for two days (240 sticks total).

Post Frying Procedure. Immediately after frying and weighing two sticks were placed into a Whirl Pak bag and frozen for analysis for fat and moisture. Four sticks were placed onto brown blotting paper (Uline 24″ kraft paper #S3575) and photographed immediately. The fried sticks were subsequently held approximately one hour, removed from the paper and re-photographed displaying the oil that had absorbed into the blotting paper.

Nutritional analysis. The two frozen mozzarella sticks from each treatment batch were ground in a coffee grinder until homogenous. The moisture content of each batch was analyzed using the CEM Smart 6 Microwave+Infrared Moisture and Solids Analyzer, and then the sample was transferred to the Oracle Rapid NMR Fat Analyzer (CEM Corporation, Matthews, N.C.) to measure the fat content.

Oxidative Stability Index (OSI). Oxidative stability of samples was analyzed using the Omnion Oxidative Stability Instrument (Rockland, Mass.). The Oxidative Stability Instrument offers an automated replacement to the Active Oxygen Method (AOCS Official Method Cd 12-57). This method provides a rapid instrumental determination of the oxidative stability of fats, oils, and other organic materials by measuring the induction period (length of time before rapid acceleration of oxidation occurs).

In this method a stream of purified air is passed through the sample which is being held in a thermo stated heating block. The effluent air from the oil or fat sample is then bubbled through a vessel containing deionized water in which the conductivity of the water is continually monitored. As oxidation proceeds, volatile organic acids are formed and are carried into the water, which increases the conductivity of the water. The change in conductivity of the water is monitored by a computer, which then provides an induction point. The induction point, (the maximum change in the rate of oxidation) as indicated by the Oil Stability Index (OSI), is positively correlated with antioxidant efficacy and the subsequent oxidative stability of the substrate. All samples were evaluated at 110° C.

Free Fatty Acids (FFA). FFA were analyzed using AOCS Ca5a-40 procedure by Eurofins, Des Moines, Iowa.

TABLE 37
Formulas for Proteus ®- V Dry aqueous solution Day 1

| Prototype | Grams | |
|---|---|---|
| Description | (g) | Percentage |
| Proteus ®- V Dry | 80 | 4.0 |
| pH 4.45 | | |
| Water | 1920 | 96.0 |

TABLE 38
Formulas for Proteus ®- V Dry aqueous solution Day 2

| Prototype | Grams | |
|---|---|---|
| Description | (g) | Percentage |
| Proteus ®- V Dry | 40 | 4.0 |
| pH 4.45 | | |
| Water | 960 | 96.0 |

TABLE 39
Formulas hydrating batter Day 1 and Day 2

| Prototype | Grams | |
|---|---|---|
| Description | (g) | Percentage |
| Batter | 80 | 30 |
| Water | 1920 | 70 |

$$Coating percentage calculation .$$

$$( \frac{breaded weight - green weight}{breaded weight} ) \times 100 = coating ( \% ) \qquad Equation 1$$

$$Yield to green weight calculation .$$

$$( \frac{fried weight}{green weight} ) \times 100 = yield to green ( \% ) \qquad Equation 2$$

$$Cook yield calculation .$$

$$( \frac{fried weight}{breaded weight} ) \times 100 = cook yield ( \% ) \qquad Equation 3$$

Statistical Analysis. Analysis of Variance (ANOVA) and Multiple Range Testing was performed using StatGraphic XVIII.

Results and Analysis. The results of this study are summarized in Table 40.

TABLE 40
Percentage pickup of Proteus ®-V by dipping

| | Wt. before | Wt. After | |
|---|---|---|---|
| | Proteus ®- | Proteus ®- | Percentage |
| Sample No. | V Dip | V Dip | Pickup |
| 1 | 42.73 | 45.03 | 5.38 |
| 2 | 43.11 | 45.35 | 5.20 |
| 3 | 42.53 | 44.91 | 5.60 |
| 4 | 42.88 | 45.36 | 5.78 |
| 5 | 42.92 | 45.56 | 6.15 |
| 6 | 45.95 | 48.51 | 5.57 |
| 7 | 43.18 | 45.68 | 5.79 |
| 8 | 40.11 | 42.35 | 5.58 |
| 9 | 42.97 | 45.48 | 5.84 |
| 10 | 41.23 | 43.69 | 5.97 |
| Average | | | 5.69 |
| Standard | | | 0.28 |
| Deviation | | | |

The target percentage pickup for these trials was set at 5%, therefore a mean value of 5.69% was acceptable. It has been found in the past using animal muscle protein solution that getting the coated products into the frying oil as soon as possible after the protein application produces a better product from a visual standpoint. This is true for breadcrumb products, but especially true for barrel breaded, flour-based coatings. The protein solution, if it sits on the coating too long tends to give a smooth appearance. For these trials, it was decided to have a separate experiment whereby the average pickup would be determined, and the results would suffice for the trials. This allowed for no stoppage of the process between dipping in protein and frying.

TABLE 41
Day 1 Trial Controls

| | | | | Yield | | | Cook |
|---|---|---|---|---|---|---|---|
| Green | Breaded | Coating | Fried | (YTG) | Fat | Moisture | Yield |
| Wt. (g) | Wt. (g) | (%) | Wt. (g) | (%) | (%) | (%) | (%) |
| 152.35 | 256.61 | 0.41 | 258.52 | 1.70 | 12.28 | 44.15 | 1.01 |
| 155.94 | 258.27 | 0.40 | 260.75 | 1.67 | 12.95 | 43.74 | 1.01 |
| 145.93 | 245.10 | 0.40 | 246.40 | 1.69 | 11.93 | 44.46 | 1.01 |
| 144.45 | 249.97 | 0.42 | 251.50 | 1.74 | 11.92 | 44.38 | 1.01 |
| 150.51 | 258.33 | 0.42 | 260.20 | 1.73 | 12.39 | 44.44 | 1.01 |
| 151.22 | 260.60 | 0.42 | 262.22 | 1.73 | 12.37 | 44.33 | 1.01 |
| 146.62 | 262.15 | 0.44 | 264.12 | 1.80 | 13.31 | 43.99 | 1.01 |
| 144.51 | 245.16 | 0.41 | 245.78 | 1.70 | 13.00 | 44.31 | 1.00 |
| 145.65 | 251.61 | 0.42 | 253.09 | 1.74 | 12.47 | 44.27 | 1.01 |
| 148.39 | 254.86 | 0.42 | 256.24 | 1.73 | 12.04 | 44.51 | 1.01 |

Averages

| | | | | | | | |
|---|---|---|---|---|---|---|---|
| 148.56^{a} | 254.27^{a} | 0.42^{a} | 255.88^{a} | 1.72^{a} | 12.47^{a} | 44.26^{a} | 1.01^{a} |

Standard Deviation

| | | | | | | | |
|---|---|---|---|---|---|---|---|
| 3.64 | 5.77 | 0.01 | 6.14 | 0.03 | 0.45 | 0.23 | 0.00 |

TABLE 42
Day 1 Trial Proteus®-V Dry

| | | | | Yield | | | Cook |
|---|---|---|---|---|---|---|---|
| Green | Breaded | Coating | Fried | (YTG) | Fat | Moisture | Yield |
| Wt. (g) | Wt. (g) | (%) | Wt. (g) | (%) | (%) | (%) | (%) |
| 147.24 | 269.78 | 0.45 | 277.08 | 1.88 | 10.35 | 44.99 | 1.03 |
| 144.51 | 258.00 | 0.44 | 265.86 | 1.84 | 9.30 | 48.04 | 1.03 |
| 158.32 | 283.16 | 0.44 | 288.15 | 1.82 | 10.24 | 44.70 | 1.02 |
| 149.90 | 269.47 | 0.44 | 276.85 | 1.85 | 9.71 | 47.04 | 1.03 |
| 147.87 | 265.51 | 0.44 | 272.40 | 1.84 | 9.45 | 48.26 | 1.03 |
| 148.32 | 270.23 | 0.45 | 278.01 | 1.87 | 9.36 | 47.14 | 1.03 |
| 147.60 | 265.26 | 0.44 | 271.87 | 1.84 | 9.34 | 47.57 | 1.02 |
| 142.59 | 257.50 | 0.45 | 263.70 | 1.85 | 9.68 | 47.54 | 1.02 |
| 149.30 | 262.35 | 0.43 | 270.04 | 1.81 | 9.38 | 47.63 | 1.03 |
| 151.44 | 260.00 | 0.42 | 267.83 | 1.77 | 9.85 | 46.71 | 1.03 |

Averages

| | | | | | | | |
|---|---|---|---|---|---|---|---|
| 148.71^{a} | 266.13^{a} | 0.44^{c} | 273.18^{c} | 1.84^{b} | 9.67^{b} | 46.96^{c} | 1.03^{b} |

Standard Deviation

| | | | | | | | |
|---|---|---|---|---|---|---|---|
| 4.01 | 7.24 | 0.01 | 6.79 | 0.03 | 0.36 | 1.14 | 0.00 |

TABLE 43
Day 2 Trial Controls

| | | | | Yield | | | Cook |
|---|---|---|---|---|---|---|---|
| Green | Breaded | Coating | Fried | (YTG) | Fat | Moisture | Yield |
| Wt. (g) | Wt. (g) | (%) | Wt. (g) | (%) | (%) | (%) | (%) |
| 148.41 | 252.38 | 0.41 | 253.46 | 1.71 | 13.43 | 43.44 | 1.00 |
| 151.68 | 253.25 | 0.40 | 256.16 | 1.69 | 12.35 | 45.47 | 1.01 |
| 140.58 | 234.09 | 0.40 | 234.33 | 1.67 | 12.14 | 45.74 | 1.00 |
| 155.89 | 265.74 | 0.41 | 268.25 | 1.72 | 12.17 | 46.86 | 1.01 |
| 167.12 | 271.63 | 0.38 | 260.58 | 1.56 | 12.83 | 46.00 | 0.96 |
| 145.19 | 247.43 | 0.41 | 249.76 | 1.72 | 11.54 | 45.95 | 1.01 |
| 148.87 | 253.89 | 0.41 | 250.01 | 1.68 | 11.93 | 45.82 | 0.98 |
| 147.80 | 243.98 | 0.39 | 250.89 | 1.70 | 13.43 | 44.43 | 1.03 |
| 159.30 | 262.30 | 0.39 | 263.61 | 1.65 | 11.68 | 46.76 | 1.00 |
| 146.08 | 245.79 | 0.41 | 246.29 | 1.69 | 12.23 | 44.77 | 1.00 |

Averages

| | | | | | | | |
|---|---|---|---|---|---|---|---|
| 151.09^{a} | 253.05^{a} | 0.40^{b} | 253.33^{a} | 1.68^{c} | 12.37^{a} | 45.52^{b} | 1.00^{a} |

Standard Deviation

| | | | | | | | |
|---|---|---|---|---|---|---|---|
| 7.36 | 10.58 | 0.01 | 9.11 | 0.04 | 0.63 | 1.00 | 0.02 |

TABLE 44
Day 2 Trial Proteus®-V Dry

| | | | | Yield | | | Cook |
|---|---|---|---|---|---|---|---|
| Green | Breaded | Coating | Fried | (YTG) | Fat | Moisture | Yield |
| Wt. (g) | Wt. (g) | (%) | Wt. (g) | (%) | (%) | (%) | (%) |
| 144.36 | 248.67 | 0.42 | 253.82 | 1.76 | 9.79 | 47.76 | 1.02 |
| 151.59 | 262.44 | 0.42 | 269.08 | 1.78 | 9.82 | 48.39 | 1.03 |
| 156.07 | 262.87 | 0.41 | 269.83 | 1.73 | 10.14 | 48.19 | 1.03 |
| 144.79 | 249.19 | 0.42 | 257.45 | 1.78 | 10.31 | 48.31 | 1.03 |
| 153.32 | 268.62 | 0.43 | 274.01 | 1.79 | 9.47 | 49.56 | 1.02 |
| 150.93 | 260.01 | 0.42 | 262.98 | 1.74 | 10.20 | 47.60 | 1.01 |
| 151.26 | 255.26 | 0.41 | 264.97 | 1.75 | 9.84 | 50.23 | 1.04 |
| 148.24 | 251.20 | 0.41 | 270.99 | 1.83 | 9.81 | 49.54 | 1.08 |
| 153.11 | 268.93 | 0.43 | 275.53 | 1.80 | 9.13 | 48.73 | 1.02 |
| 149.43 | 258.99 | 0.42 | 260.81 | 1.75 | 9.48 | 48.12 | 1.01 |

Averages

| | | | | | | | |
|---|---|---|---|---|---|---|---|
| 150.31^{a} | 258.62^{a} | 0.42^{a} | 265.95^{b} | 1.77^{d} | 9.80^{b} | 48.64^{d} | 1.01^{b} |

Standard Deviation

| | | | | | | | |
|---|---|---|---|---|---|---|---|
| 4.01 | 7.24 | 0.01 | 6.80 | 0.03 | 0.35 | 0.82 | 0.02 |

TABLE 45
Metrics of raw string cheese

| | Fat | Moisture |
|---|---|---|
| Sample No. | (%) | (%) |
| 1 | 8.73 | 55.80 |
| 2 | 8.57 | 55.15 |
| 3 | 9.19 | 55.03 |
| Average | 8.83 | 55.33 |
| Standard | 0.32 | 0.41 |
| Deviation | | |

Plant-based Proteus®-V worked well in blocking fat from being absorbed onto the coating of fried mozzarella sticks. A 5.4%-7.0% yield to green increase was found on the samples dipped in Proteus®-V. The products containing Proteus®-V were found to have an increased moisture content of 6.1%-6.9% higher than controls. In both trials there was a two percent increase in the amount of coating applied to the Proteus®-V samples, which could account for some of the increase yield to green. However, the increased moisture content, and less coating found in the used oil, would also assist in increasing yield. The fat content of sticks dipped in Proteus®-V was 20.8%-22.5% lower in total crude fat than undipped samples, potentially allowing a better nutritional panel. However, to get an estimate on the amount of oil that is truly used in the frying operation, the fat content of the unaffected internal raw cheese stick should be discounted from the total fat content. This is due to the raw cheese stick undergoing no changes during the par-fry operation. When this calculation was done the amount of oil that was reduced when dipping the sticks into Proteus®-V was 31.265-42.18%. With the cost of edible oils ever increasing, a large savings would be beneficial to processors. Cook yields were shown to be 1.00%-1.98% higher in the Proteus®-V product, which is much lower than the yield-to-green yields. This may suggest that moisture retention alone may not fully explain the yield-to-green increased yields; possibly there is a larger role in the retention of coating onto the substrate as it travels through the oil.

Proteus®-V dipped product developed a slightly lighter yellow color when compared to the controls (FIGS. 45 & 47)) In the past, the addition of dextrose (0.75% w/w) to the protein solution has been shown to produce a darker color. In production, the breadcrumbs would have the dextrose added directly to them producing a more consistent product than addition to the protein.

The blotting paper results visually showed Proteus®-V product that absorbed less oil in the Day 1 trial (FIG. 46) and possibly equal absorption or slightly more absorption in the Day 2 trial (FIG. 48). Proteus®-V and other proteins produce a micro surface layer surrounding the substrate, which potentially blocks moisture from escaping the product during the frying operation. At the same time blocking fat from penetrating the coating. We have seen in the past, frying oil instead of penetrating, gathers and pools at the substrate's surface. This may give varying results in a blotting paper evaluation. One method to lower the fat content is to set up an air knife over the belt and gently blow the pooled surface oil off the product.

Examining the diagonal cut samples in FIG. 49, both the Controls and Proteus®-V dipped samples had excellent adhesion between the cheese stick and the coating. This is an important attribute to fried products, where if a gap between the two phases develops, it is considered a defect.

Additionally, the oil quality of product produced using Proteus®-V was shown to be similar or better in stability than control oils. Photographs of oil samples after frying from Day 1 and Day 2 trials are shown in FIGS. 50 and 51. In both trials the control oils had more particles and a fine brown sludge that was found on the bottom of the oil. In typical frying operations, this brown sludge is what gets transferred to the filters and removed. The sludge that gets disposed results in a lower yield. An anecdotal estimate of how much yield loss occurs, when a local frozen fish processor in Gloucester, Mass. would dispose of four 55-gallon barrels of sludge for every 40,000 lbs of product produced. The weight of the sludge would be approximately 1,600 lbs. (4×400 lbs), which represents a 4% yield loss. The sludge develops from a breaking off from the coating as the product travels through the frying oil and collects in a continuous filter. A partial reason for oil degradation in frying operations is from the sludge being subjected to the continuous high heat prior to being removed by the filter. The browning is a result of the breading undergoing high heat Maillard reactions similar to toasting a slice of bread.

Two methods were used to evaluate the frying oil used to fry the mozzarella sticks. Free fatty acid analysis measures the degree of hydrolytic rancidity that has occurred in the oil and the OSI or oxidative stability index, evaluates hydrocarbon breakdown, which leads to rancidity. Free fatty acids measurements performed on the controls and Proteus®-V treated oils showed that very little oxidation had occurred to either oil with a reading of 0.05% for both. The voluntary industry standard for free fatty acids in fresh oil is ≤0.05% and oils with values of ≥ 2.0% are discarded.

In both batches of oil used for the manufacture of mozzarella sticks, the oil with the Proteus®-V was numerically better and significantly better (ρ<0.05) in Batch #2 than the controls when the oxidative stability index was measured (FIG. 52).

To summarize, using Proteus®-V as a topical spray in production, suggests a method to increase yield-to-green, lower fat percentage, increase moisture percentage, and stabilize oil quality in par-fried mozzarella sticks. This could possibly result in lower production costs and improve nutrition for processors of similar types of products, and could fit into plant-based, or meat-based categories.

The cost of oils has risen drastically over the previous year, thus a method that leads to its use reduction would be welcomed. Commonly used oils in food production have increased in cost by 152% over the last two years². Using a price of $0.90/lb. for oil, the estimated savings to the processor using Proteus®-V would be $0.02- $0.03/lb. of finished product

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

It should be further appreciated that minor dosage and formulation modifications of the composition and the ranges expressed herein may be made and still come within the scope and spirit of the present invention.

It is also to be understood that the formulations and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Where a range of values is provided, it is understood that each intervening value, to the tenth of the unit of the lower limit unless the context clearly dictates otherwise, between the upper and lower limit of that range, and any other stated or intervening value in that stated range, is encompassed within the scope of the present disclosure. The upper and lower limits of these smaller ranges may independently be included in the smaller ranges, and are also encompassed within the scope of the present disclosure, subject to any specifically excluded limit in the stated range. Where the stated range includes one or both of the limits, ranges excluding either or both of those included limits are also included in the scope of the present disclosure. All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, 10) contained within the range. In this specification and the appended claims, the singular forms “a,” “an” and “the” include plural reference unless the context clearly dictates otherwise. All combinations of method steps or process steps as used herein can be performed in any order, unless otherwise specified or clearly implied to the contrary by the context in which the referenced combination is made

To the extent that the terms “includes” or “including” or “have” or “having” are used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A” or “B” or both “A” and “B”. When the Applicant intends to indicate “only A or B but not both” then the term “only A or B but not both” or similar structure will be employed. Thus, use of the term “or” herein is the inclusive, and not the exclusive use. Also, to the extent that the terms “in” or “into” are used in the specification or the claims, it is intended to additionally mean “on” or “onto.” In this specification and the appended claims, the singular forms “a,” “an” and “the” include plural reference unless the context clearly dictates otherwise.

The foregoing description has been presented for the purposes of illustration and description. It is not intended to be an exhaustive list or limit the invention to the precise forms disclosed. It is contemplated that other alternative processes and methods obvious to those skilled in the art are considered included in the invention. The description is merely examples of embodiments. It is understood that any other modifications, substitutions, and/or additions may be made, which are within the intended spirit and scope of the disclosure. From the foregoing, it can be seen that the exemplary aspects of the disclosure accomplish at least all of the intended objectives.

1. A process for reducing absorption of oil and/or fat into uncooked food during the cooking of food with oil and/or fat comprising:
a. preparing a pea protein composition by mixing a pea protein with water and/or an acid in order to achieve a pH within the range of about 4 to about 6; and
b. adding the pea protein composition to a surface of the uncooked food prior to cooking the food in oil and/or fat;
wherein the percentage of fat blocked from transferring to the cooked food is at least 20% as compared to fat blocked from transferring to food cooked without the pea protein composition.

2. The process of claim 1 further comprising the step of frying the uncooked food.

3. The process of claim 1 wherein the pea protein composition is applied to the uncooked food by dipping the uncooked food in the pea protein composition or spraying the pea protein composition onto the uncooked food.

4. The process of claim 1 wherein the pea protein composition is mixed with a coating that is applied to the surface of the uncooked food prior to cooking the food in oil and/or fat.

5. The process of claim 4 wherein the coating is a batter or a bread crumb mixture.

6. The process of claim 1 wherein the pea protein composition is a dry powder.

7. The process of claim 1 wherein the pea protein composition is a liquid, suspension, or emulsion.

8. The process of claim 1, wherein the pea protein composition further comprises at least one antioxidant.

9. The process of claim 1, wherein the pea protein solution further comprises a plant-based extract.

10. A process for pre-treating an uncooked food prior to cooking the uncooked food in oil and/or fat comprising the step of applying a pea protein composition with a pH in the range of about 4 to 6 to the uncooked food surface in an amount effective to reduce the fat transferred to the cooked food by at least 20% when compared to the amount of fat transferred to food cooked without the pea protein composition.

11. The process of claim 10 wherein the pea protein composition is applied to the uncooked food by dipping the uncooked food in the pea protein composition or spraying the pea protein composition onto the uncooked food.

12. The process of claim 10 wherein the pea protein composition is mixed with a coating that is applied to the surface of the uncooked food prior to cooking the food in oil and/or fat.

13. The process of claim 12 wherein the coating is a batter or a bread crumb mixture.

14. The process of claim 10 wherein the pea protein composition is a dry powder.

15. The process of claim 10 wherein the pea protein composition is a liquid, suspension, or emulsion.

16. The process of claim 10 wherein the pea protein composition further comprises at least one antioxidant, a plant-based extract, and/or mixtures thereof.

17. A method for reducing overall fat absorption of a food during frying comprising adding a pea protein composition with a pH in the range of about 4 to 6 to the uncooked food surface in an amount effective to reduce the fat transferred to the cooked food by at least 20% when compared to the amount of fat transferred to food cooked without the pea protein composition.

18. The method of claim 17 wherein the pea protein composition is applied to the uncooked food by dipping the uncooked food in the pea protein composition or spraying the pea protein composition onto the uncooked food.

19. The method of claim 17 wherein the pea protein composition is incorporated into a coating for the uncooked food.

20. The method of claim 17 wherein the pea protein composition further comprises at least one antioxidant, a plant-based extract, and/or mixtures thereof.
